(19) United States
(12) Patent Application Publication
(10) Pub. No.: US 2012/0258369 A1
(43) Pub. Date: Oct. 11, 2012

(54) LITHIUM SECONDARY BATTERY AND CATHODE ACTIVE MATERIAL THEREFOR

(75) Inventors: Shohei YOKOYAMA, Nagoya-city (JP); Nobuyuki KOBAYASHI, Nagoya-city (JP); Tsutomu NANATAKI, Toyoake-city (JP); Koichi KONDO, Nagoya-city (JP); Yukinobu YURA, Nagoya-city (JP); Kei SATO, Tokai-city (JP)

(73) Assignee: NGK Insulators, Ltd., Nagoya-City (JP)

(21) Appl. No.: 13/367,813

(22) Filed: Feb. 7, 2012

Related U.S. Application Data
(60) Provisional application No. 61/472,805, filed on Apr. 7, 2011.
(60) Provisional application No. 61/496,721, filed on Jun. 14, 2011.
(60) Provisional application No. 61/527,306, filed on Aug. 25, 2011.
(60) Provisional application No. 61/537,763, filed on Sep. 22, 2011.

(51) Int. Cl. H01M 4/485; H01B 1/00

(52) U.S. Cl. 429/231.1; 252/500

(57) ABSTRACT

The lithium secondary battery cathode active material having a layered rock salt structure is characterized in that the material is formed of a plurality of primary particles having a mean particle size of 0.01 to 5 μm, and contains secondary particles having a mean particle size of 1 to 100 μm and an aspect ratio, which is a ratio of long axis diameter to short axis diameter, of 1.0 or more and less than 2; and that the primary particles forming the secondary particles have a (003) plane orientation degree of 50% or higher.

### TECHNICAL FIELD

The present invention relates to a lithium secondary battery (the battery may be referred to as a “lithium ion secondary battery”) and to a cathode active material therefor. More particularly, the invention relates to a cathode active material having a layered rock salt structure and to a lithium secondary battery having a cathode containing the cathode active material.

### BACKGROUND ART

Lithium secondary battery cathodes are widely known to be formed from a cathode active material having a so-called α-NaFeO₂-type layered rock salt structure. Conventionally, such a cathode active material is in the form of cobalt-containing materials (i.e., a lithium oxide containing cobalt as a main transition metal element, typically LiCoO₂) (see, for example, Japanese Patent Application Laid-Open (kokai) No. 2003-132887).

However, in recent years, in order to reduce the amount of use of cobalt, which is an expensive material with considerably large price fluctuations, the cathode active material has come to be formed from a nickel-containing material (i.e., a lithium oxide containing nickel as a main transition metal element, typically LiNiO₂). Particularly, a multi-component nickel-based material such as a nickel-cobalt-based material or a nickel-cobalt-aluminum-based material has come to be employed (see, for example, Japanese Patent Application Laid-Open (kokai) No. 2006-127955).

In such a cathode active material, intercalation/deintercalation of lithium ions (Li⁺) occurs through crystal planes other than the (003) plane (i.e., lithium ion intercalation/deintercalation plane) (e.g., the (101) plane and the (104) plane). Through intercalation/deintercalation of lithium ions, charge-discharge operations of a lithium secondary battery are carried out. It has been known that the cell characteristics of lithium secondary batteries can be improved by exposing as many lithium ion intercalation/deintercalation planes of the cathode active material as possible to the surface (outer surface) which is in contact with electrolyte (see, for example, WO 2010/074304).

Note that diffusion of lithium ions in the cathode active material is known to occur in the in-plane direction of the (003) plane (i.e., in the direction parallel to the (003) plane).

### SUMMARY OF THE INVENTION

In lithium secondary batteries, there is demand for further improvement in cell characteristics, in particular the charge-discharge characteristic at high rate (hereinafter referred to simply as “rate characteristic”) and the cycle characteristic. The present invention has been conceived in order to attain the object.

The present inventors have conducted extensive studies in order to attain the object, and have found that the above object can be attained by bringing to be substantially uniaxially oriented the (003) planes of a cathode active material particle. Specifically, a large number of single-crystal primary particles forming the cathode active material particle are arranged so that the (003) planes are in parallel with one another to the greatest possible extent. The present invention has been accomplished on the basis of this finding.

A characteristic feature of one aspect of the present invention resides in that the lithium secondary battery cathode active material having a layered rock salt structure has such properties as described below:

the lithium secondary battery cathode active material is formed of a large number of primary particles having a mean particle size of 0.01 to 5 μm;

the lithium secondary battery cathode active material contains secondary particles which have a mean particle size of 1 to 100 μm and an aspect ratio, which is expressed as a value calculated by dividing a long axis diameter by a short axis diameter, of 1.0 or more and less than 2 (preferably 1.1 to 1.5); and

the primary particles forming the secondary particles have a (003) plane orientation degree of 50% or higher (preferably 70% or higher).

A characteristic feature of another aspect of the present invention resides in a lithium secondary battery having a cathode including a cathode active material layer and an anode including an anode active material layer, wherein:

the cathode active material layer contains a cathode active material in the form of secondary particles each being formed of a mass of a plurality of singe-crystal primary particles of a lithium complex oxide having a layered rock salt structure;

the primary particles have a mean particle size of 0.01 to 5 μm; and

the secondary particles have an aspect ratio, which is expressed as a value calculated by dividing a r long axis diameter by a short axis diameter, of 1.0 or more and less than 2 (preferably 1.1 to 1.5), a mean particle size of 1 to 100 μm, and a (003) plane orientation degree of 50% or higher (preferably 70% or higher).

As used herein, the term “layered rock salt structure” refers to a crystal structure in which lithium layers and layers of a transition metal other than lithium are arranged in alternating layers with an oxygen layer therebetween; i.e., a crystal structure in which transition metal ion layers and lithium ion layers are arranged in alternating layers via oxide ions (typically, α-NaFeO₂ type structure: cubic rock salt type structure in which transition metal and lithium are arrayed orderly in the direction of the [111] axis).

The lithium complex oxide having a layered rock salt structure which may be used in the present invention is typically lithium cobaltate (LiCoO₂). Alternatively, a solid solution containing cobalt with nickel, manganese, or the like may also be employed. Specific examples of such compounds include lithium nickelate, lithium manganate, lithium nickel manganate, lithium nickel cobaltate, lithium cobalt nickel manganate, and lithium cobalt manganate. These compounds may further contain one or more elements such as Mg, Al, Si, Ca, Ti, V, Cr, Fe, Cu, Zn, Ga, Ge, Sr, Y, Zr, Nb, Mo, Ag, Sn, Sb, Te, Ba, and Bi.

Specifically, there may be employed lithium complex oxides represented by the following formula (1):

LiₚMeO₂,

wherein 0.9≦p≦1.3, and Me represents at least one metallic element selected from the group consisting of Mn, Ti, V, Cr, Fe, Co, Ni, Cu, Al, Mg, Zr, B, and Mo, and represented by the following formula (2):

xLi₂MO₃-(1−x)LiₚMeO₂,

wherein 0<x<1 and 0.9≦p≦1.3, and each of M and Me represents at least one metallic element selected from the group consisting of Mn, Ti, V, Cr, Fe, Co, Ni, Cu, Al, Mg, Zr, B, and Mo.

The metallic element “Me” in any of formulas (1) and (2) may be at least one metallic element having an average oxidation number of “+3” and is preferably at least one metallic element selected from the group consisting of Mn, Ni, Co, and Fe. Similarly, the metallic element “M” in formula (2) may be at least one metallic element having an average oxidation number of “+4” and is preferably at least one metallic element selected from the group consisting of Mn, Zr, and Ti.

The nickel-cobalt-aluminum-based cathode active material particularly preferably employed in the present invention has a composition represented by the following formula:

Liₚ(Niₓ,Co_{y},Al_{z})O₂,

wherein 0.9≦p≦1.3, 0.6<x≦0.9, 0.05≦y≦0.25, 0≦z≦0.2, and x+y+z=1.

The range of p is preferably 0.9≦p≦1.3, more preferably 1.0≦p≦1.1. When p is less than 0.9, discharge capacity is lowered, whereas when p is 1.3 or more, discharge capacity is lowered, and a large amount of gas is generated in the battery during charging. Both cases are not preferred.

When x is less than 0.6, discharge capacity is lowered, whereas when x is in excess of 0.9, stability is lowered. Both cases are not preferred. Thus, x is preferably 0.7 to 0.85.

When y is 0.05 or less, the crystal structure of the nickel-based oxide has poor stability, whereas when y is in excess of 0.25, discharge capacity is lowered. Both cases are not preferred. Thus, y is preferably 0.10 to 0.20.

When z is in excess of 0.2, discharge capacity is lowered, which is not preferred. Thus, z is preferably 0.02 to 0.1.

The term “primary particle” refers to an independently existing particle which is not comprised of an aggregate. In particular, the term “single-crystal primary particle” refers to a primary particle which has no crystal grain boundary therein, whereas the term “secondary particle” refers to aggregated primary particles or a mass of a plurality (large number) of single-crystal primary particles.

The term “aspect ratio” refers to the ratio of diameter of a particle in the long-axis direction to that in the short-axis direction. When a particle has an aspect ratio approximate to 1, the shape of the particle is approximately spherical. Meanwhile, the aspect ratio of the primary particle preferably falls within the range of 1.0 to 2.0, more preferably falls within the range of 1.1 to 1.5.

The term “(003) plane orientation degree” refers to the ratio of the number of (003) planes having a predetermined orientation to the total number of the (003) planes present in the cathode active material particle (secondary particle) (represented by percentage). For example, when the cathode active material particle has a (003) plane orientation degree of 50%, 50% of the numerous (003) planes ((003) planes in the layered rock salt structure) present in the cathode active material particle are arranged in parallel to one another. Thus, the higher the value, the higher the (003) plane orientation degree of the cathode active material particle (secondary particle). In other words, a large number of single-crystal primary particles forming the cathode active material particle are arranged so that the (003) planes are in parallel with one another to the greatest possible extent when the value is high. In contrast, the lower this value, the lower the (003) plane orientation degree of the cathode active material particle (secondary particle). In other words, a large number of single-crystal primary particles forming the cathode active material particle are arranged so that the (003) planes are oriented in various directions when the value is low.

As described above, the aforementioned secondary particle is formed of a large number of primary particles. Since the primary particle is a single-crystal particle, the orientation degree of the primary particle itself is not need to be taken into consideration. The orientation state of a large number of primary particles forming the secondary particle is estimated as the (003) plane orientation state of the entire secondary particle. Thus, the (003) plane orientation degree of the entire secondary particle may be referred to as the “(003) plane orientation degree of the primary particles forming the secondary particle.”

The (003) plane orientation degree may be determined through, for example, the following procedure. Specifically, the plate surface or cross-section (finished by means of a cross-section polisher (CP), focused ion beam (FIB), or the like) of a secondary particle is observed through EBSD (electron backscatter diffractometry), TEM, or a similar technique. The orientation of the (003) planes of the primary particles forming the secondary particle is determined, and the ratio of the primary particles having a small variation in orientation angle (≦±10°) to all the primary particles present is calculated.

In the cathode active material having the aforementioned characteristics, the (003) planes are substantially uniaxially oriented, whereby lithium ions and electrons can smoothly move along the in-plane direction of the (003) plane. Therefore, the thus-obtained cathode active material particle has enhanced lithium-ion-conductivity and electron-conductivity. In addition, since the formed cathode active material particles are generally spherical, many lithium ion intercalation/deintercalation planes are exposed to the surface (outer surface) which is in contact with electrolyte. Therefore, the present invention realizes further enhanced cell characteristics (particularly rate characteristic and cycle characteristic), as compared to those conventionally attained.

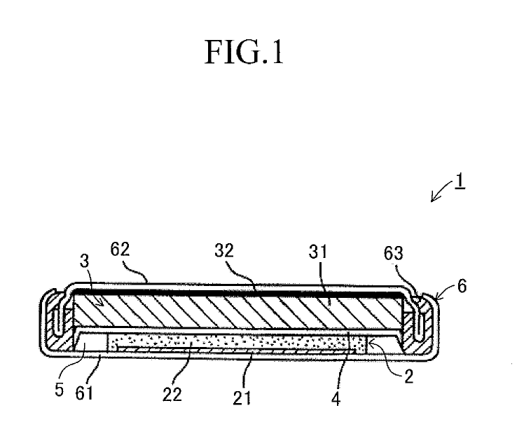

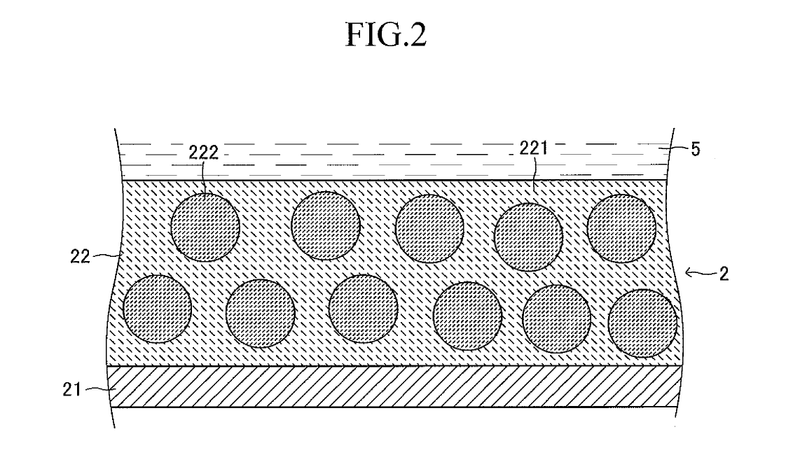

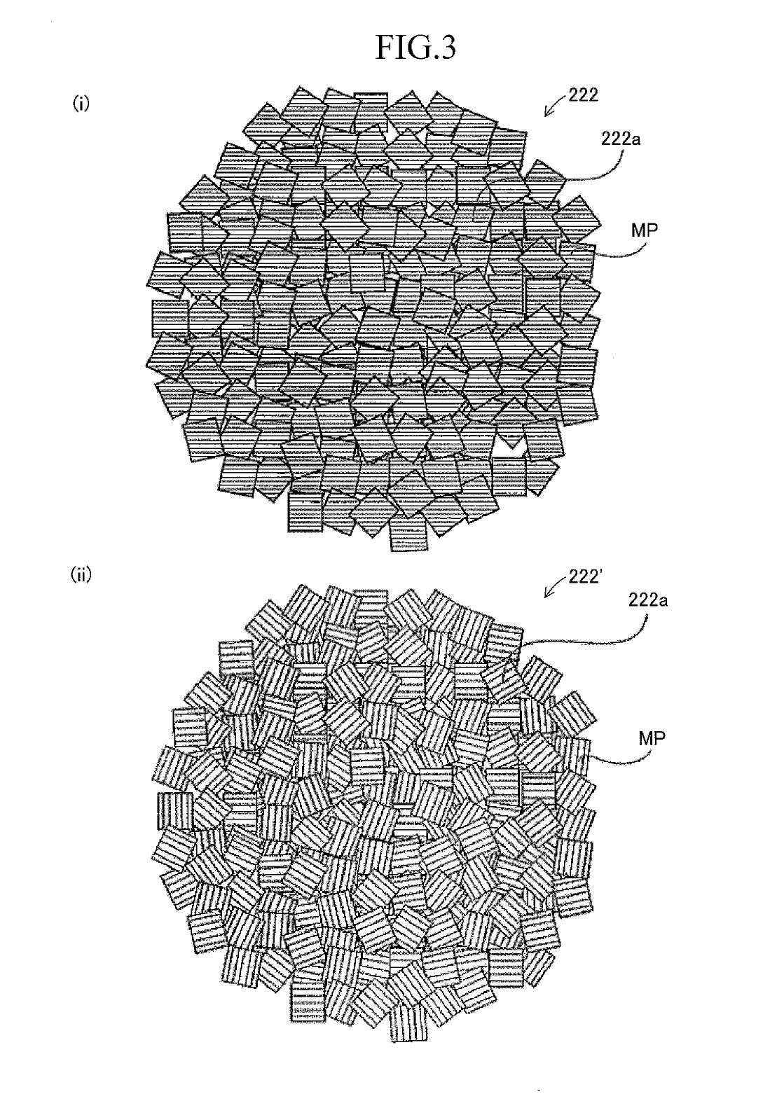

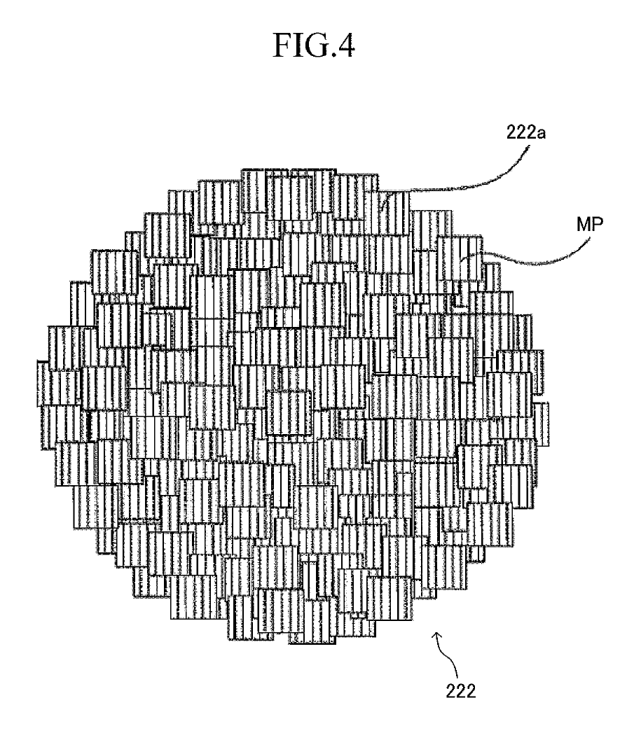

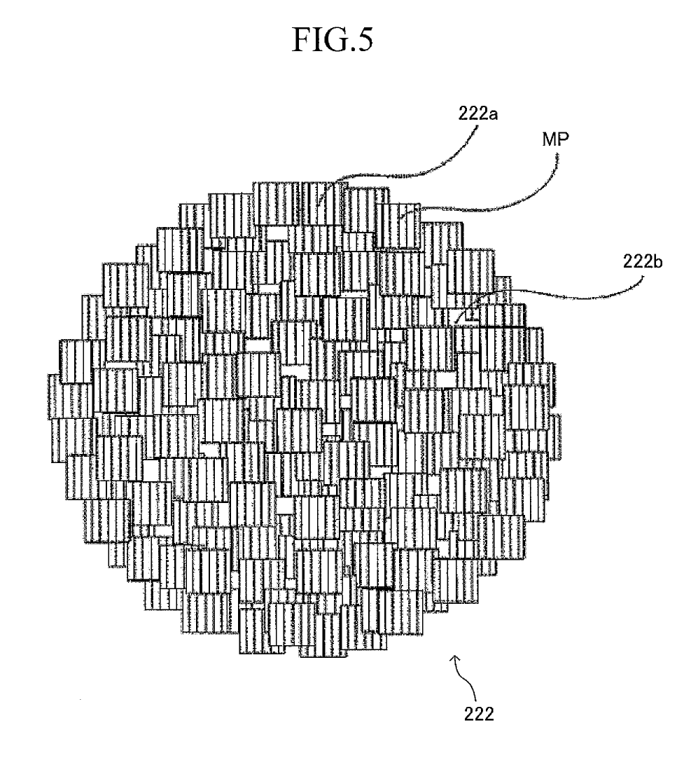

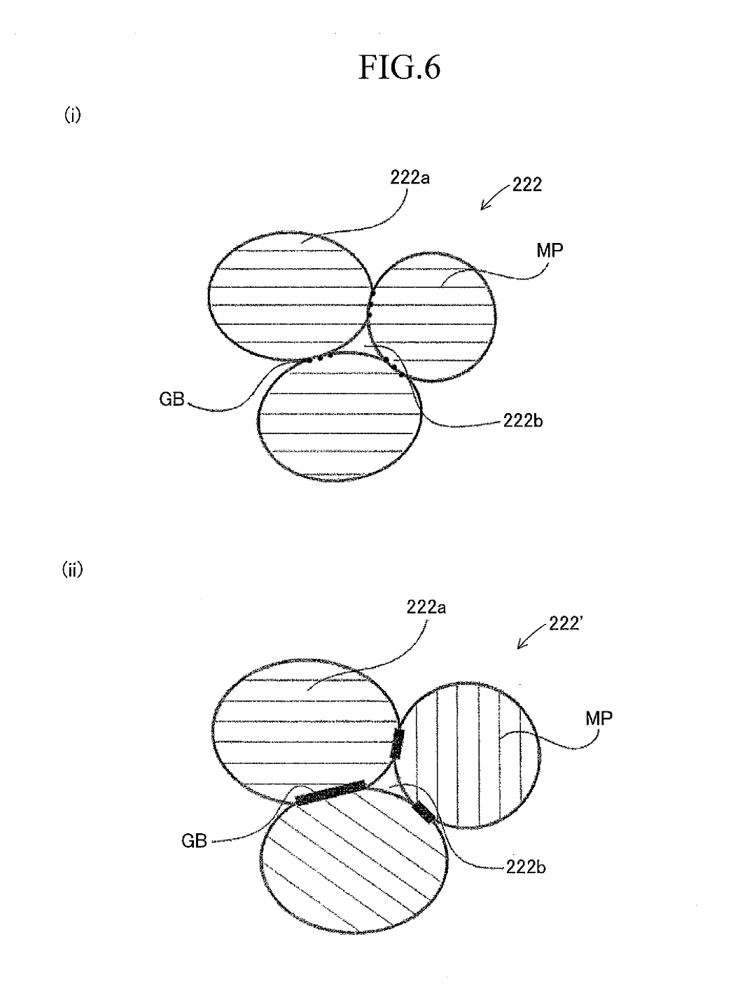

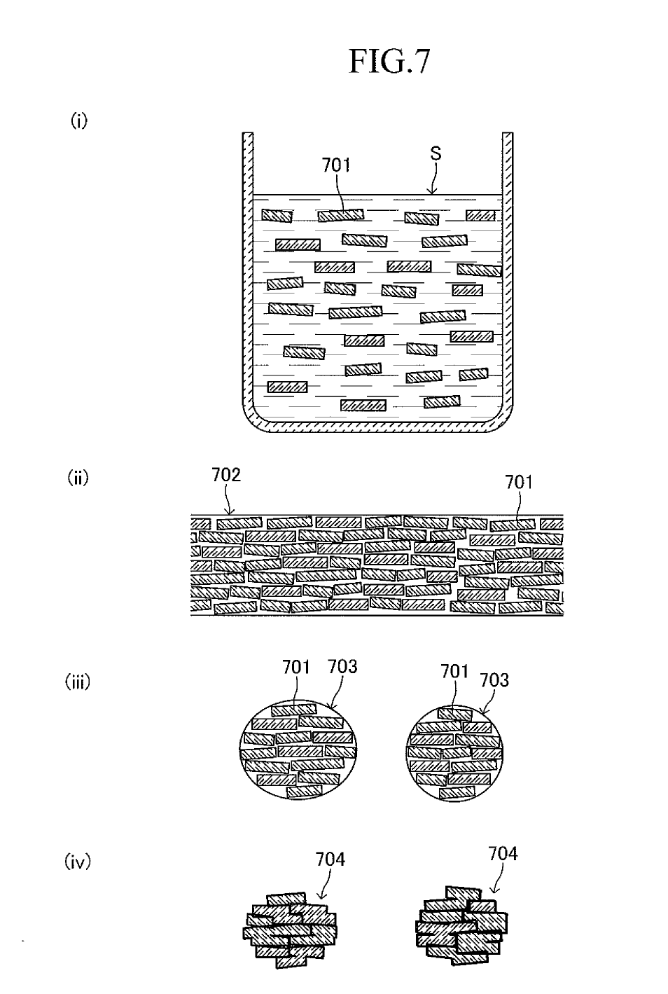

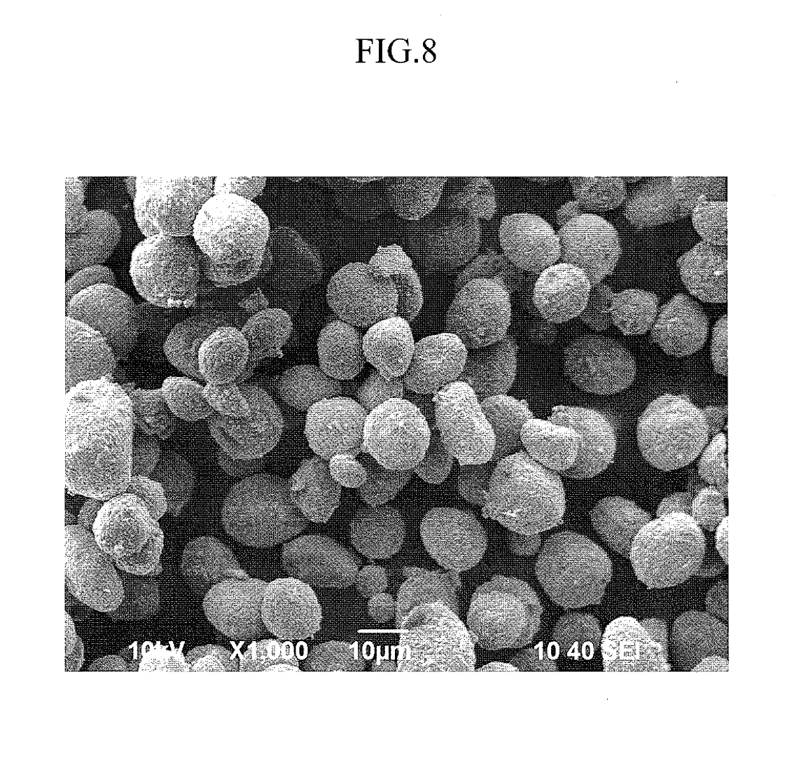

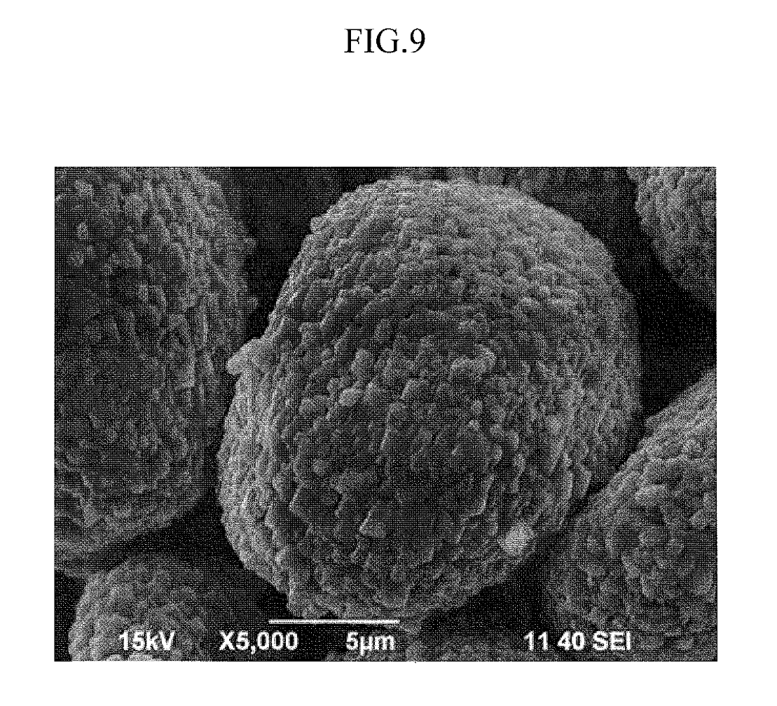

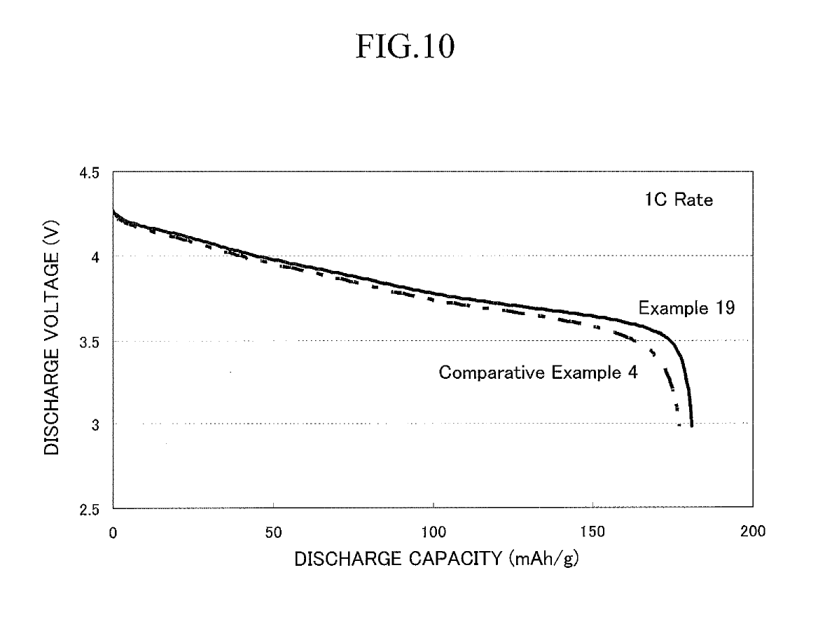

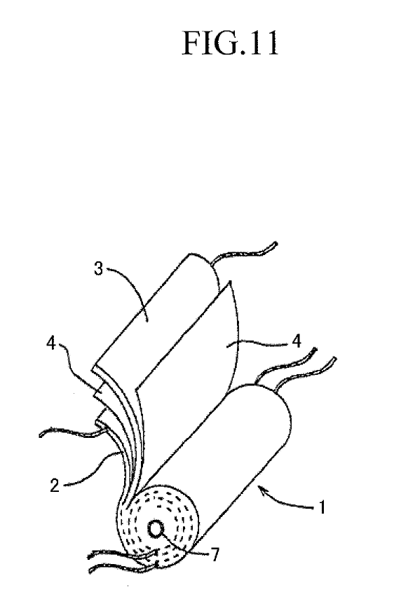

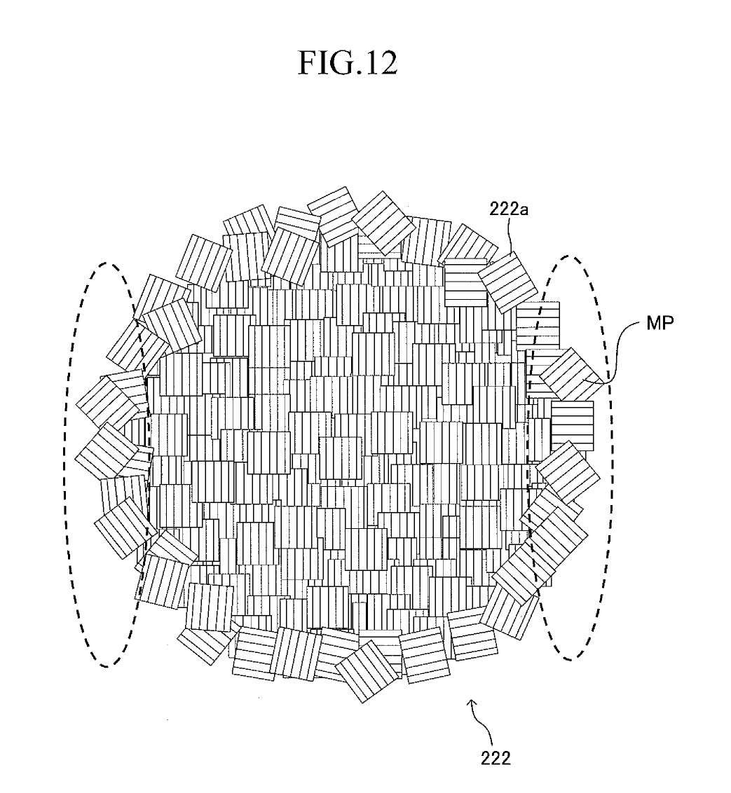

### BRIEF DESCRIPTION OF THE DRAWINGS

[FIG. 1] A sectional view of the schematic configuration of a lithium secondary battery according to an embodiment of the present invention.

[FIG. 2] An enlarged cross-section of a cathode plate shown in FIG.

[FIG. 3] (i) An enlarged schematic view of an example of the cathode active material particle of the present invention shown in FIG. 2, and (ii) an enlarged schematic view of a conventional cathode active material particle (Comparative Example).

[FIG. 4] An enlarged schematic view of another example of the cathode active material particle of the present invention shown in FIG. 2

[FIG. 5] An enlarged schematic view of still another example of the cathode active material particle of the present invention shown in FIG. 2

[FIG. 6] (i) An enlarged schematic partial view of an example of the cathode active material particle of the present invention shown in FIG. 5, and (ii) an enlarged schematic partial view of a conventional cathode active material particle (Comparative Example).

[FIG. 7] A schematic flow of an example of the method for producing the cathode active material particles according to one embodiment of the present invention shown in FIGS. 3(i), 5, and 6.

[FIG. 8] An SEM (scanning electron microscope) photoimage of the cathode active material particles of Example 19.

[FIG. 9] A higher-magnification SEM (scanning electron microscope) photoimage of the cathode active material particles of Example 19 shown in FIG. 8.

[FIG. 10] A graph showing discharge characteristics of batteries employing cathode active material particles of an Example and a Comparative Example.

[FIG. 11] A perspective view of another embodiment of the lithium secondary battery of the present invention.

[FIG. 12] An enlarged schematic view of still another example of the cathode active material particle shown in FIG. 2.

### MODES FOR CARRYING OUT THE INVENTION

Preferred embodiments of the present invention will next be described with reference to examples and comparative examples. The following description of the embodiments is nothing more than the specific description of mere example embodiments of the present invention to the possible extent in order to fulfill description requirements (descriptive requirement and enabling requirement) of specifications required by law. Thus, as will be described later, naturally, the present invention is not limited to the specific configurations of embodiments and examples to be described below. Modifications that can be made to the embodiments and examples are collectively described herein principally at the end, since insertion thereof into the description of the embodiments would disturb understanding of consistent description of the embodiments.

### 1. CONFIGURATION OF LITHIUM SECONDARY BATTERY

FIG. 1 is a cross-sectional view of the schematic configuration of a lithium secondary battery 1, which is an embodiment of the present invention. As shown in FIG. 1, the lithium secondary battery 1 of the embodiment is a coin cell of a so-called liquid type and has a cathode plate 2, an anode plate 3, a separator 4, an electrolyte 5, and a cell casing 6.

The cathode plate 2 is formed by laminating a cathode collector 21 and a cathode active material layer 22. Similarly, the anode plate 3 is formed by laminating an anode active material layer 31 and an anode collector 32.

The lithium secondary battery 1 is fabricated by stacking the cathode collector 21, the cathode active material layer 22, the separator 4, the anode layer 31, and the anode collector 32, in this order, and putting the resultant stacked body and the electrolyte 5 containing a lithium compound as an electrolyte substance into the cell casing 6 (including a cathode-side container 61, an anode-side container 62, and an insulating gasket 63) in a liquid-sealable manner.

The members forming the lithium secondary battery 1 of the present embodiment other than the cathode active material layer 22 may be formed from widely known various materials. For example, the anode active material forming the anode layer 31 may be an amorphous carbonaceous material (e.g., soft carbon or hard carbon), a high-graphitized carbon material (e.g., synthetic graphite or natural graphite), acetylene black, etc. Among these materials, a high-graphitized carbon material having a large lithium capacity is preferably used. The anode material prepared from such an anode active material is applied onto the anode collector 32 (e.g., metal foil), to thereby form the anode plate 3.

Examples of the organic solvent suitably employed in the non-aqueous electrolyte 5 include carbonate ester solvents such as ethylene carbonate (EC), diethyl carbonate (DEC), dimethyl carbonate (DMC), and propylene carbonate (PC); single solvents such as γ-butyrolactone, tetrahydrofuran, and acetonitrile, and mixtures thereof.

The electrolyte substance contained in the electrolyte 5 may be a lithium complex boron compound such as lithium hexafluorophosphate (LiPF₆) or lithium borofluoride (LiBF₄); a lithium halide such as lithium perchlorate (LiClO₄), etc. Generally, one or more members of the above electrolyte substances are dissolved in the aforementioned organic solvent, to thereby prepare the electrolyte 5. Among the electrolyte substances, LiPF₆ is preferably used, since it has resistance to oxidation-induced decomposition and provides high electrical conductivity of the produced non-aqueous electrolyte.

Notably, since the members forming the lithium secondary battery 1 of the present embodiment other than the cathode active material layer 22 are widely known, no further detailed descriptions thereof are made in the specification.

### 2. CONFIGURATIONS OF CATHODE ACTIVE MATERIAL LAYER AND CATHODE ACTIVE MATERIAL PARTICLES

FIG. 2 is an enlarged cross-section of the cathode plate 2 shown in FIG. 1. As shown in FIG. 2, the cathode active material layer 22 is formed of a binder 221, and cathode active material particles 222 and a conducting aid (e.g., carbon) uniformly dispersed in the binder 221, and is joined to the cathode collector 21. More specifically, the cathode plate 2 is formed by mixing cathode active material particles 222, a binder 221 (e.g., poly(vinylidene fluoride) (PVDF)), and a conducting aid (e.g., acetylene black) at predetermined proportions, to thereby prepare a cathode material, and applying the cathode material onto the surface of the cathode collector 21 (e.g., metal foil).

The cathode active material particles 222 assume microparticles having a mean particle size of 1 to 100 μm and being generally spherical or generally spheroidal. Specifically, the cathode active material particles 222 are formed so as to have an aspect ratio of 1.0 or more and less than 2 (preferably 1.1 to 1.5).

FIG. 3(i) is an enlarged schematic view of an example of the cathode active material particle 222 shown in FIG. 2, and FIG. 3(ii) is an enlarged schematic view of a conventional cathode active material particle 222′ (Comparative Example). As shown in FIG. 3(i), the cathode active material particle 222 assumes a secondary particle which is an aggregate of a plurality of single-crystal primary particles 222a (mean particle size: 0.01 to 5 μm) of a lithium complex oxide having a layered rock salt structure. The single-crystal primary particles 222a are formed so that the (003) planes denoted by “MP” in FIG. 3(i) are oriented in an in-plane direction. That is, the (003) planes are formed so that they intersect the plate surface of the single-crystal primary particles 222a. Needless to say, all the (003) planes in one single-crystal primary particle 222a are arranged in parallel one another.

In the cathode active material particle 222, (003) planes are highly uniaxially oriented. In other words, in the cathode active material particle 222, a large number of single-crystal primary particles 222a forming each cathode active material particle are arranged so as to attain a uniform (003) orientation, or so that the (003) planes are in parallel with one another to the greatest possible extent. More specifically, the cathode active material particle 222 is formed so that the (003) plane orientation degree is adjusted to 50% or higher. That is, the ratio of the number of (003) planes having the same orientation to the total number of the (003) planes present in a plurality of single-crystal primary particles 222a included in the cathode active material particle 222 is adjusted to 50% or higher.

In contrast, as shown in FIG. 3(ii), in a conventional cathode active material particle 222′, a large number of single-crystal primary particles 222a forming each cathode active material particle are arranged so that the (003) plane orientations are not uniform.

### 3. Action and Effects of the Cathode Active Material Particles

In the cathode active material particle 222, the (003) planes are substantially uniaxially oriented (i.e., the (003) plane orientation degree is controlled to 50% or higher), whereby resistance to lithium ion diffusion between single-crystal primary particles 222a (i.e., in the grain boundary) is reduced. As a result, lithium ion conductivity and electron conductivity can be enhanced. Thus, the charge-discharge characteristics (particularly, the rate characteristic) of the lithium secondary battery 1 can be remarkably enhanced.

Meanwhile, microcracking which is generally caused between single-crystal primary particles 222a (i.e., in the grain boundary) by volume expansion/contraction associated with repeated charge-discharge processes tends to occur in a direction parallel with the (003) plane, which serves as a lithium ion diffusion plane and an electron conduction plane. In other words, the microcracking occurs in a direction which does not cause resistance to lithium ion diffusion or does not affect electron conductivity. As a result, deterioration in charge-discharge characteristics (particularly, rate characteristic), which would otherwise be caused by repeated charge-discharge cycles, can be prevented.

The cathode active material particles 222 preferably have a (003) plane orientation degree of 70% or higher, particularly preferably 90%. As the orientation degree increases, more (003) planes are arranged in parallel one another in the in-plane direction (i.e., direction suitable for lithium ion diffusion) in a large number of single-crystal primary particles 222a included in the cathode active material particle 222. Thus, as the orientation degree increases, the distance of lithium ion diffusion is shortened, and the resistance to lithium ion diffusion is reduced, as described above, whereby the charge-discharge characteristics of the lithium secondary battery 1 can be remarkably enhanced. Therefore, even when the cathode active material particles 222 are employed as a cathode material of a liquid-type lithium secondary battery 1, and the mean particle size of the cathode active material particles 222 is increased in order to enhance durability, capacity, and safety, high rate characteristic can be maintained by increasing the orientation degree.

The single-crystal primary particles 222a have a mean particle size of 0.01 to 5 μm, preferably 0.05 to 3 μm, more preferably 0.05 to 1.5 μm.

Through adjusting the mean particle size of the single-crystal primary particles 222a to fall within the aforementioned range, the crystallinity of the single-crystal primary particles 222a is maintained. When the mean particle size of the single-crystal primary particles 222a is less than 0.1 μm, the crystallinity of the single-crystal primary particles 222a is impaired, and the output characteristic of lithium secondary battery 1 may be impaired in some cases. However, in the cathode active material of the present invention, even when the single-crystal primary particles 222a have a mean particle size of 0.1 to 0.01 μm, no considerable drop in output characteristic is observed.

Also, through adjusting the mean particle size of the single-crystal primary particles 222a to fall within the aforementioned range, cracking of the cathode active material particle 222 as a secondary particle can be prevented to the greatest possible extent, even when volume expansion/contraction of the single-crystal primary particles 222a occurs during a charge-discharge process. In contrast, when the mean particle size of the single-crystal primary particles 222a is in excess of 5 μm, volume expansion/contraction of the single-crystal primary particles 222a during a charge-discharge process generates stress, which may cause cracking the cathode active material particle 222 as a secondary particle.

The cathode active material particles 222 as secondary particles have a mean particle size of 1 to 100 μm, preferably 2 to 70 μm, more preferably 3 to 50 μm. Through adjusting the mean particle size of the cathode active material particles 222 to fall within the range, the cathode active material filling density of the cathode active material particle 222 is ensured (i.e., percent filling is enhanced). In addition, a flat electrode surface can be formed, while the output characteristic of the lithium secondary battery 1 is maintained. In contrast, when the mean particle size of the cathode active material particles 222 is less than 1 μm, the cathode active material filling density may fall, whereas when the mean particle size of the cathode active material particles 222 is in excess of 100 μm, the output characteristic of the lithium secondary battery 1 may be impaired, and the flatness of the electrode surface may be reduced.

The distribution profile of the mean particle size of the cathode active material particles 222 may be sharp or broad, and may have a plurality of peaks. In the case where the distribution profile of the mean particle size of the cathode active material particles 222 is not sharp, the cathode active material filling density of the cathode active material layer 22 may be increased, or bonding between the cathode active material layer 22 and the cathode collector 21 may be enhanced, whereby the rate characteristic and cycle characteristics can be further improved.

The cathode active material particle 222 has an aspect ratio of 1.0 or more and less than 2.0, preferably 1.1 to 1.5. Through adjusting the aspect ratio of the cathode active material particle 222 to fall within the above range, there can be formed, between the cathode active material particles 222, a suitable space which can ensure paths for diffusion of lithium ions in the thickness direction of the cathode active material layer 22, the lithium ions contained in the electrolyte 5 incorporated in the cathode active material layer 22, even when the cathode active material filling density of the cathode active material layer 22 is increased. In this case, the output characteristic of the lithium secondary battery 1 can be further enhanced.

When the aspect ratio of the cathode active material particle 222 is 2.0 or more, the cathode active material particle 222 tends to be incorporated such that the long-axis direction of each particle aligns to the plate surface direction of the cathode collector 21 during formation of the cathode active material layer 22. In this case, the path length for diffusion of lithium ions in the thickness direction of the cathode active material layer 22, the lithium ions contained in the electrolyte 5 incorporated in the cathode active material layer 22, increases, possibly causing a drop in output characteristic of the lithium secondary battery 1.

The aspect ratio of the single-crystal primary particles 222a preferably falls within the range of 1.0 to 2.0, more preferably falls within the range of 1.1 to 1.5 for the following reason.

Grain growth of a single-crystal primary particle of a cathode active material tends to occur in a direction parallel to the (003) plane which serves as a conduction plane of lithium ions and electrons. Therefore, in general, an aspect ratio tends to be large and form of the particle tends to be flat with respect to this kind of a single-crystal primary particle. Additionally, the (003) plane, which is a crystal plane having difficulty in intercalation/deintercalation of lithium ions and electrons, tend to be exposed widely to the surface.

From this point of view, in the present embodiment, the aspect ratio of the single-crystal primary particles 222a falls within the range of 2.0 or less. Accordingly, contact of crystal planes (i.e. planes other than the (003) plane) through which lithium ions and electrons easily intercalate and deintercalate with each other can be sufficiently ensured at contact portions which adjacent single-crystal primary particles 222a contact each other. Therefore, lithium-ion-conductivity and electron-conductivity are surely obtained in the cathode active material particle 222 as the secondary particle. Especially, this effect can be prominent when the cathode active material particle 222 may have a high orientation degree of the crystal plane.

In the case where the cathode active material particle 222 is formed at high density (i.e., in a state where a large number of single-crystal primary particles 222a are aggregated without giving excess space) as shown in FIG. 4, the cathode active material filling density of the cathode active material layer 22 can be increased, which is advantageous for attaining high capacity.

As shown in FIG. 5, through incorporating voids 222b into a portion of the cathode active material particle 222, an electrolyte or a conducting material may be placed in the voids 222b. As a result, rate characteristic can be improved while high capacity is maintained. In addition, stress generated during a charge-discharge process can be relaxed, whereby capacity deterioration, which would otherwise be caused by repeated charge-discharge process, may be mitigated (cyclic characteristic may be enhanced). The degree of incorporation of voids 222b may be defined by “voidage,” “mean pore size,” or “open pore ratio.”

FIG. 6(i) is an enlarged schematic partial view of the cathode active material particle 222 shown in FIG. 5, and FIG. 6(ii) is an enlarged schematic partial view of a conventional cathode active material particle 222′ (Comparative Example).

As shown in FIG. 6(i), (003) planes (denoted by “MP” in FIG. 6) of single-crystal primary particles 222a forming the cathode active material particle 222 having voids 222b are oriented in a specific direction, whereby resistance at the grain boundary GB (grain boundary resistance) is reduced. By virtue of reduced grain boundary resistance and the presence of voids 222b containing an electrolyte or a conducting material, the optimum lithium ion conductivity and electron conductivity can be attained in the cathode active material particles 222 having voids 222b.

As shown in FIG. 6(ii), (003) planes of single-crystal primary particles 222a forming a conventional cathode active material particle 222′ having voids 222b are not oriented in a specific direction. In this case, although an electrolyte or a conducting material enters the voids 222b, lithium ion conduction paths and electron conduction paths are narrowed, resulting in a drop in lithium ion conductivity and electron conductivity. In most cases, the narrowest portion of a conduction path (i.e., a neck portion) serves as a grain boundary GB. Thus, when the grain boundary resistance is high, a considerable drop in conductivity is observed. Notably, grain boundary resistance cannot be actually measured, but an image representing the magnitude of grain boundary resistance is given at the grain boundary GB in each drawing of FIG. 6.

As used herein, the term “voidage” refers to the volume proportion of voids 222b (pores: including open pores and closed pores) in the cathode active material particle 222 of the present invention. “Voidage” may also be referred to as “porosity.” “Voidage” can be calculated from, for example, bulk density and true density. Specifically, the “voidage” is obtained by dividing the bulk density (measured through the Archimedes' method) by the true density (measured by means of a picnometer), to thereby obtain a relative density, and the obtained relative density is input to the following equation. In the measurement of bulk density, the cathode active material particle are boiled in water in order to sufficiently remove air remaining in the pores. When the sample has a small pore size, the pores of the sample are impregnated in advance with water by means of a vacuum impregnation apparatus (CitoVac, product of Struers), and the thus-treated sample is subjected to boiling treatment.

Voidage (%)=(1−relative density)×100 Equation:

The voidage is preferably 60% or less, more preferably 50% or less, still more preferably 40% or less. When the voidage is controlled to fall within the range, the aforementioned effects (i.e., improvement in rate characteristic and cycle characteristic) can be attained while high capacity is maintained without impairing the capacity.

The “mean pore size” is the mean diameter of the pores present in the cathode active material particle 222. The “diameter” is generally the diameter of an imaginary sphere under the assumption that each pore is reduced to a sphere having the same volume or cross-sectional area as that of the pore. According to the present invention, the “mean value” is preferably calculated on the number basis. The mean pore size may be obtained through, for example, a widely known method such as image processing of a cross-sectional SEM image or the mercury penetration method. More specifically, the “mean pore size” may be measured through the mercury penetration method by means of a mercury penetration micropore distribution analyzer “AutoPore IV9510,” product of Shimadzu Corporation.

The mean pore size is preferably 0.01 to 5 μm, more preferably 0.05 to 4.5 μm, still more preferably 0.1 to 4.0 μm. When the mean pore size is in excess of 5 μm, relatively large pores are provided. In the presence of such large pores, the amount (amount/volume) of cathode active material which is responsible for charge and discharge is reduced. Furthermore, stress concentration readily occurs at some sites in such large pores, whereby difficulty is encountered to attain the effect of uniformly releasing the internal stress. When the mean pore size is less than 0.01 μm, difficulty is encountered to incorporate a conducting material or an electrolyte into pores, and the stress-releasing effect by the pores is insufficient. In this case, improvement in rate characteristic and cycle characteristic may fail to be attained, while high capacity is maintained.

As used herein, the term “open pore ratio” refers to the ratio by volume of open pores to all the voids (pores) contained in the cathode active material particle 222. As used herein, the term “open pore” refers to voids 222b (pores) which are contained in the cathode active material particle 222 and which communicate with the outside of the cathode active material particle 222. “Open pore ratio” may be calculated from the total number of open pores and closed pores determined by bulk density, and the number of closed pores determined by apparent density. In this case, parameters used for calculation of “open pore ratio” may be determined through, for example, Archimedes' method.

When the open pores include an electrolyte or a conducting material, the inner walls (surfaces) of the open pores provided in the cathode active material particles 222 serve as suitable lithium ion intercalation/deintercalation surfaces. Therefore, an open pore ratio of 50% or more is preferred from the viewpoint of improvement of rate characteristic, as compared with the case where closed pores, which are merely pores (portions not responsible for charge and discharge), are present at large proportions. Particularly in the dense portion where the voidage is 20% or less, rate characteristic is further improved, and cycle characteristic is also improved, while high capacity is maintained, by elevating the open pore ratio (e.g., 70% or higher).

In order to form voids 222b having the aforementioned “voidage,” “mean pore size,” or “open pore ratio” of interest, a void-forming material is added as an additive to the raw material. The void-forming material employed is preferably a particulate or fibrous substance which decomposes (vaporizes or is carbonized) in the subsequent calcination step. Specific examples of preferably employed pore-forming materials include theobromine, nylon, graphite, and organic synthetic resins such as phenolic resin, poly(methyl methacrylate), polyethylene, poly(ethylene terephthalate), and foamable resin, in the form of particle or fiber. Needless to say, if no such a void-forming material is added, the cathode active material particles 222 having the aforementioned “voidage,” “mean pore size,” or “open pore ratio” of interest can be formed through appropriately tuning the particle size of the raw material particles, the firing temperature employed in the calcination (thermal treatment) step, etc.

The voids 222b may further contain an additional compound such as an electrolyte or a conducting material, another lithium ion cathode active material providing excellent rate characteristic, or a cathode active material having a different particle size. When such an additional compound is present in the voids 222b, rate characteristic and cycle characteristic are further improved. Examples of the technique of incorporating the additional compound into the voids 222b include a technique in which an additional compound is applied in advance onto the void-forming material, followed by firing under appropriate firing condition, and a technique in which an additional compound is added to raw material particles during formation of the cathode active material particles 222.

Single-crystal primary particles 222a or cathode active material particles 222 may be coated with another material. Depending on the properties of the coating material, the thermal or chemical stability of the material of the particles is improved, or rate characteristic is improved. Examples of the coating material which may be used in the invention include chemically stable compounds such as alumina, zirconia, and alumina fluoride; highly lithium-dispersible materials such as lithium cobaltate; and materials having high electron conductivity such as carbon.

### 4. Summary of the Production Method

The cathode active material particles 222 (see, for example, FIG. 3(i), and the same applies throughout the specification) may be produced through, for example, the below-described production method. FIG. 7 is a schematic flow of an example of the production method.

### (1) Preparation of Raw Material Particles

A mixture of compounds of Li, Co, Ni, Mn, Al, etc. in the form of particles at appropriate proportions may be used so as to attain a cathode active material composition of LiMO₂. Specific examples of such a raw material which may be used include a mixture of compounds of Co, Ni, Mn, Al, etc. in the form of particles containing no lithium compound (e.g., (Co,Ni,Mn)Oₓ, (Co,Ni,Al)Oₓ, (Co,Ni,Mn)OHₓ, and (Co,Ni,Al)OHₓ)). The mixture of the particle is molded, and a lithium compound is caused to react with the molded product, to thereby yield cathode active material particles having a predetermined composition.

In order to enhance the aforementioned orientation degree, particles of a hydroxide (e.g., (Co,Ni,Mn)OHₓ or (Co,Ni,Al)OHₓ) are preferably employed as a raw material. Such a hydroxide is formed of flat primary particles having flat (001) planes, and the primary particles thereof are readily oriented in the below-mentioned forming step. When reacted with a lithium compound, the (001) planes transfers the orientation to the (003) planes of the cathode active material having a predetermined composition. Therefore, when such plate-like raw material particles are used, the (003) planes of the cathode active material particle 222 can be readily oriented.

In order to promote grain growth or compensate for volatilization of lithium species during firing, a lithium compound may be added in an excessive amount of 0.5 to 40 mol % to raw material particles. Also, for promoting grain growth, a low-melting-point oxide (e.g., bismuth oxide), a low-melting-point glass (e.g., borosilicate glass), lithium fluoride, lithium chloride, or the like may be added to raw material particles in an amount of 0.001 to 30 wt. %. Furthermore, a void-forming material may be added for forming voids having the aforementioned “voidage,” “mean pore size,” or “open pore ratio” of interest.

### (2) Forming of Raw Material Particles

The thus-prepared raw material particles are formed into a self-standing sheet-like compact having a thickness of 100 μm or less. As used herein, the term “self-standing” of the “self-standing compact” refers to the same as “independent” of the below-mentioned “independent sheet.” That is, the “self-standing compact” is defined as a compact which maintains its sheet-like compact shape by itself. The “self-standing compact” also encompasses a compact which cannot maintain its sheet-like compact shape by itself at a certain moment but which has been formed into sheet through attaching to a substrate or film formation and has been removed from the substrate before or after firing. Specifically, an as-extruded sheet is a “self-standing compact” immediately after molding. A film of a slurry cannot be handled as self-standing film before drying, but becomes a “self-standing compact” after drying or removal from the substrate. The concept “sheet-like” encompasses plate-like, flaky, flake-like, etc.

No particular limitation is imposed on the forming method, so long as the raw material particles are present in the compact thereof with arranged crystal orientations. For example, through forming film of a slurry containing raw material particles through the doctor blade method, a (self-standing sheet-like) compact in which the raw material particles are present with arranged crystal orientations can be produced. In one specific procedure of the doctor blade method, a slurry S containing raw material particles 701 is applied onto a flexible substrate (e.g., organic polymer sheet (e.g., PET film)) (see FIG. 7(i)), and the thus-applied slurry S is dried to solid, to form a dry film. Then, the dry film was removed from the aforementioned substrate, whereby a compact 702 in which the raw material particles 701 are oriented (present with arranged crystal orientations) is yielded (see FIG. 7(ii)).

Alternatively, the aforementioned compact 702 may be produced by applying a slurry containing raw material particles onto a heated drum of a drum drier and scraping off the dried matter by means of a scraper. Still alternatively, the aforementioned compact 702 may be produced by a slurry containing raw material particles onto a heated disk of a disk drier and scraping off the dried matter by means of a scraper. Yet alternatively, the aforementioned compact 702 may be produced by extruding a green material containing raw material particles.

In a step of preparing a slurry or a green material before forming, an additive such as a binder or a plasticizer may be appropriately added to a dispersion of raw material particles in an appropriate dispersion medium. The type and amount of the additive such as a binder are appropriately tuned so that the filling density and orientation degree of raw material particles during forming or the shape of the crushed product obtained in the below-mentioned crushing step can be controlled to conditions of interest. Specifically, when the compact has high softness before crushing, the crushed product tends to have a large aspect ratio. Thus, the type and amount of the additive such as a binder may be appropriately modified so that the softness of the compact before crushing is not excessively high. For example, in order to control the softness of the compact before crushing, the compact may be dried at about 200 to about 500° C. at which the binder degrades or decomposes.

In the case where a slurry raw material particles is used, preferably, the viscosity thereof is adjusted to 0.1 to 5 Pa·s or the slurry is defoamed under reduced pressure. In the case where an additional compound is incorporated into voids, preferably, a slurry containing the compound and raw material particles is prepared.

The compact 702 preferably has a thickness of 120 μm or less, more preferably 100 μm or less. The thickness of the compact 702 is preferably 1 μm or more. When the compact 702 has a thickness of 1 μm or more, production of self-standing sheet-like compact is facilitated. Since the thickness of the compact 702 is an important factor for directly determining the mean particle size of the cathode active material particles 222, the thickness is appropriately modified in accordance with the uses of the particles.

### (3) Crushing of Compact

The thus-produced compact 702 is crushed so that the cathode active material particles 222 have an aspect ratio of interest. Crushing may be performed through the following techniques: pressing to mesh by means of a spatula or the like; crushing by means of a soft crusher such as a pin-mill; collision of sheet-like flakes in an air flow (specifically, by means of an air classifier); rotating jet-mill; pot crushing; barrel polishing; etc.

The crushed product may be subjected to sphering. Through sphering, the finally obtained cathode active material particles 222 assume a generally spherical or a generally spheroidal shape. When the cathode active material particles 222 assume a generally spherical or a generally spheroidal shape, increased areas of lithium ion intercalation/deintercalation planes of the outer surfaces of the particles are exposed, and the cathode active material filling rate of the cathode active material layer 22 increases, whereby cell characteristics are improved.

Sphering may be performed through the following techniques: collision of crushed particles in an air flow to round the crushed particles (e.g., air classification or hybridization); collision of crushed particles in a container to round the crushed particles (e.g., by means of a hybrid mixer or a high-speed agitator/mixer, barrel polishing, etc.); mechanochemical method; and melting of the surfaces of crushed particles by hot blow. Sphering and crushing may be performed separately or simultaneously. When an air classifier is employed, sphering and crushing can be simultaneously.

In order to facilitate crushing or sphering, the compact to be treated may be degreased or thermally treated (fired or calcined) in advance. For example, as described above, in order to control the softness of the compact before crushing, the compact may be dried at a high temperature at which the binder degrades or decomposes. In the case where the raw material particles are plate-like particles (in the case of hydroxide particles), the compact before crushing has an internal structure in which a large number of plate-like raw material particles are arranged in parallel with the plate surface of the compact in a pseudo-aggregate form. In this case, the compact readily causes anisotropy in mechanical strength, and the crushed product tends to have a large aspect ratio. That is, difficulty is encountered in controlling the aspect ratio to 2 or less. Therefore, in this case, the compact is preferably subjected to calcination before crushing, or to the below-described firing step (lithium-incorporation step) before crushing.

Through calcination before crushing, the internal structure of the compact before crushing and before firing (before incorporation of lithium) changes to a structure in which oxide particles having an isotropic shape are necked, whereby the aspect ratio of the crushed product is easily adjusted to 2 or less. The calcination temperature is preferably 600 to 1,100° C. When the calcination temperature is lower than 600° C., the aforementioned necking does not sufficiently proceeds, making the calcined compact to be fragile, and the particle size of the crushed product is excessively reduced. When the calcination temperature is higher than 1,100° C., sintering of the raw material excessively proceeds, and the subsequent reaction during lithium incorporation is disturbed, thereby failing to synthesize lithium complex oxide having a target composition. The calcination before crushing is particularly preferred for a material having a composition which does not cause adverse effect such as phase separation in calcination (e.g., nickel-cobalt-based, nickel-cobalt-aluminum-based, or nickel-aluminum-based material (i.e., material containing nickel but containing no manganese)).

In the case where calcination is not performed before crushing, the suitable orientation of raw material particles (i.e., plate-like raw material particles) 701 remains in the obtained crushed product (i.e., cathode active material precursor particles 703) (see FIG. 7(iii)). In other words, the cathode active material precursor particle 703 assumes a raw material particle ensemble containing a large number of plate-like raw material particles 701, in which the raw material particles 701 are substantially uniaxially oriented.

In contrast, when calcination is performed before crushing, the aforementioned necking (grain growth) proceeds, whereby the orientation of raw material particles (i.e., plate-like raw material particles) 701 does not remain in the obtained crushed product (i.e., cathode active material precursor particles 704) (see FIG. 7(iv)). In other words, the cathode active material precursor particle 704 has the same internal structure as that of the cathode active material precursor particle 703 which has been thermally treated. Therefore, the cathode active material precursor particles 703 are crushed but are not calcined, and the crushed product is calcined, whereby the cathode active material precursor particles 704 can be formed.

Products having an aspect ratio falling outside the desired range (e.g., a large aspect ratio due to insufficient crushing) and micropowder obtained during crushing or sphering may be reused as a raw material.

As described above, the cathode active material precursor particles 703 or 704 having an aspect ratio of 1.0 or more and less than 2.0 (preferably 1.1 to 1.5) and a specific internal structure are formed. The cathode active material precursor particles can provide the cathode active material particles 222 having an aspect ratio of interest and a (003) plane orientation state of interest.

Meanwhile, the cathode active material precursor particle 703 or 704 which is formed by a method other than above-mentioned (1) to (3) can be used. For example, the cathode active material precursor particle 703 or 704 which is obtained by a method described below and is a hydroxide having a composition of (Co, Ni, Mn)OHₓ or (Co, Ni, Al)OHₓ etc. can be used. This cathode active material precursor particle 703 or 704 has the aspect ratio of 1.0 or more and less than 2.0, generally spherical shape and a (001) plane orientation state of interest.

Firstly, a liquid solution containing Co, Ni and Mn or Co, Ni and Al, a complexing agent and an alkali metal hydroxide are poured with continuous stirring into a reaction vessel which seed crystal particles of a hydroxide having a composition of (Co, Ni, Mn)OHₓ or (Co, Ni, Al)OHₓ etc. are already poured therein. Then metallic complex salt of Co, Ni and Mn or Co, Ni and Al is generated. Next, this metallic complex salt is degraded by the alkali metal hydroxide. Then hydroxide of Co, Ni and Mn or Co, Ni and Al is precipitated around the seed crystal particles in such a manner that crystal orientation (orientation of (001) plane of (Co, Ni, Mn)OHₓ or (Co, Ni, Al)OHₓ) is aligned. The afore-mentioned particles are obtained by repeating such processes of generation, degradation and precipitation of metallic complex salt in the reaction vessel with circulation.

(4) Mixing with Lithium Compound

The thus-yielded cathode active material precursor particles 703 or 704 is mixed with a lithium compound (e.g., lithium hydroxide or lithium carbonate), to thereby prepare a mixture before firing. Mixing is may be performed via dry mixing, wet mixing, or a similar technique. The lithium compound preferably has a mean particle size of 0.1 to 5 μm. When the mean particle size of the lithium compound is 0.1 μm or more, handling of the lithium compound is easier from the viewpoint of hygroscopicity, whereas when the mean particle size of the lithium compound is 5 μm or less, reactivity with the crashed product increases. In order to further increase the reactivity, the amount of lithium may be increased 0.5 to 40 mol % in excess.

### (5) Firing (Non-Preliminary Firing: Incorporation of Lithium)

Through firing the aforementioned non-fired mixture through an appropriate method, lithium is incorporated into the cathode active material precursor particles 703 or 704, to thereby produce the cathode active material particles 222. In one specific procedure, the aforementioned non-fired mixture is placed into a case, and the case is put into a furnace, where firing is performed. Through firing, synthesis of the cathode active material, sintering of the grains, and grain growth are completed. As described above, since the (001) planes of the raw material particles are oriented in a compact (cathode active material precursor particles 703 or 704), the crystal orientation is transferred, whereby the cathode active material particles 222 having a predetermined composition in which (003) planes are suitably uniaxially oriented can be produced.

The firing temperature is preferably 600° C. to 1,100° C. When the firing temperature is lower than 600° C., grain growth is insufficient, and the orientation degree lowers in some cases. When the firing temperature is higher than 1,100° C., decomposition of cathode active material and volatilization of lithium proceed, thereby failing to realize the target composition in some cases. The firing time is preferably 1 to 50 hours. When the firing time is shorter than 1 hour, the orientation degree may be lowered, whereas when the firing time is longer than 50 hours, the energy consumed for firing excessively increases in some cases.

The firing atmosphere must be appropriately selected so as not to proceed decomposition during firing. In the case where volatilization of lithium proceeds, preferably, lithium carbonate or a similar compound is added to the same case, to thereby provide a lithium-rich atmosphere. In the case where release of oxygen or further reduction proceeds, firing is preferably performed in an atmosphere of high oxygen partial pressure. After completion of firing, in order to solve inter-particle adhesion or aggregation of the cathode active material particles 222 or to regulate the mean particle size of the cathode active material particles 222, crushing or classification (may be also referred to as “secondary crushing” or “secondary classification”, since it is performed after the aforementioned crushing or classification (before firing)) may be appropriately performed. Alternatively, the aforementioned crushing step may be performed after firing. In other words, the crushing step (or the classification step) may be performed only after firing.

### 5. EXAMPLES

The present invention will next be described in detail by way of examples, which should not be construed as limiting the invention thereto. Unless otherwise specified, the units “part(s)” and “%” in the Examples and Comparative Examples are mass-basis units. Measurement of physical properties and evaluation of characteristics were carried out through the following methods. For the purpose of simplification of description, the cathode active material particles 222 are referred to simply as “secondary particles,” and the mean particle size thereof as “secondary particle size.” Also, the single-crystal primary particles 222a is referred to simply as “primary particles,” and the mean particle size thereof as “primary particle size.”

[Secondary Particle Size (μm)]

By means of a laser diffraction/scattering particle size distribution analyzer (model “LA-750,” product of Horiba Ltd.), the median diameter (D50) of secondary particles in water (dispersion medium) was measured, to thereby obtain the secondary particle size.

[Primary Particle Size (μm)]

FE-SEM (field-emission scanning electron microscope, model “JSM-7000F,” product of JEOL Ltd.) was employed. The magnification of the SEM was adjusted so that 10 or more primary particles were included in a vision field, and an SEM image of the sample was taken. An inscribed circle was drawn in each of the 10 primary particles observed in the SEM image, and the diameter of the inscribed circle was determined. The thus-obtained diameters were averaged, to thereby obtain the primary particle size.

### [Aspect Ratio]

The aforementioned FE-SEM was employed. The magnification of the SEM was adjusted so that 10 or more secondary particles were included in a vision field, and an SEM image of the sample was taken. The long-axis diameter and short-axis diameter of each of the 10 secondary particles in the SEM image were determined, and the long-axis diameter was divided by the short-axis diameter. The thus-obtained ratios were averaged, to thereby obtain the aspect ratio. An aspect ratio of the primary particle was obtained by a similar way.

### [Orientation Degree (%)]

Powder of secondary particles was placed on a glass substrate so as to prevent overlap of the secondary particles to the greatest possible extent. The powder was transferred to adhesive tape, and the tape was embedded in synthetic resin. The resin piece was polished so that the plate surfaces of the secondary particles or the polished surface thereof could be observed, to thereby provide an observation sample. In observation of plate surface, the sample was subjected to finish polishing by means of a vibration-rotating polisher by use of colloidal silica (0.05 μm) serving as an abrasive. In cross-sectional observation, the sample was polished by means of a cross-section polisher (CP).

The thus-prepared samples were subjected to secondary particle crystal orientation analysis through EBSD (electron backscatter diffraction) imaging with measurement software “OIM Data Collection” and analysis software “OIM Analysis” (products of TSL Solutions). The measurement was performed in a vision field where 10 or more primary particles were observed in a secondary particle at a pixel resolution of 0.1 μm. Through the analysis, the angle of each (003) plane of each primary particle with respect to the measurement surface (polished surface) was determined.

A histogram (number of particles vs. angle) showing an angle profile was drawn, and the angle at which the number of primary particles reached the highest level (peak value) was employed as the tilt angle θ of the (003) plane with respect to the secondary particle measurement surface. In each of the analyzed secondary particles, the number of primary particles having a (003) plane tilted at θ±10° was counted. Through dividing the number of such primary particles by the total number of the primary particles, the (003) plane orientation degree of the analyzed secondary particle was calculated. The analysis was performed for 10 different secondary particles. The thus-obtained values were averaged, to thereby obtain the (003) plane orientation degree.

### [Percent Rate Capacity Maintenance (%)]

A coin cell as shown in FIG. 1 was fabricated from the thus-produced secondary particles, and the following charge-discharge operations were carried out. Firstly, constant-current charging was carried out at 0.1 C rate of current until the cell voltage became 4.3 V; subsequently, constant-voltage charging was carried out under a current condition of maintaining the cell voltage at 4.3 V, until the current dropped to 1/20, followed by 10 minutes rest; and then, constant-current discharging was carried out at 0.1 C rate of current until the cell voltage became 3.0 V, followed by 10 minutes rest. These charge-discharge operations consisted one cycle, and two cycles in total were repeated under a condition of 25° C. The discharge capacity in the second cycle was measured, to thereby obtain the “discharge capacity at a 0.1 C rate.”

Subsequently, the above two cycles of charge-discharge operations were repeated, except that the current upon charging was maintained at a 0.1 C rate and that upon discharging changed to a 2 C rate. The discharge capacity in the second cycle was measured, to thereby obtain the “discharge capacity at a 2 C rate.”

“Discharge capacity at a 2 C rate” was divided by “discharge capacity at a 0.1 C rate,” and the ratio was employed as percent rate capacity maintenance (as percentage).

### 5-1: Nickel-Based Composition

### Example 1

### (1) Preparation of Raw Material Particles and Slurry Containing the Same

A mixture Ni(OH)₂ powder (product of Kojundo Chemical Lab. Co., Ltd.), Co(OH)₂ powder (product of Kojundo Chemical Lab. Co., Ltd.), and Al₂O₃.H₂O (product of SASOL) having proportions by mole among Ni, Co, and Al of 75:20:5 was prepared. The mixture was pulverized by means of a ball mill for 16 hours, to thereby prepare a powder of raw material particles.

The thus-prepared raw material particle powder (100 parts) was mixed with a dispersion medium (toluene:isopropanol (by mass)=1:1) (100 parts), a binder (polyvinyl butyral: product No. BM-2; product of Sekisui Chemical Co. Ltd.) (10 parts), a plasticizer (DOP: di(2-ethylhexyl)phthalate; product of Kurogane Kasei Co., Ltd.) (4 parts), and a dispersant (product name RHEODOL SP-030, product of Kao Corp.) (2 parts). The resultant mixture was stirred under reduced pressure for defoaming, and the viscosity thereof was adjusted to 3 to 4 Pa·s, to thereby form a slurry. The viscosity was measured by means of an LVT-type viscometer (product of Brookfield Co., Ltd.).

### (2) Forming of Raw Material Particles and Heating (Calcination)

The thus-prepared slurry was formed into a sheet on a PET film through the doctor blade process (feed rate: 1 m/s) such that the thickness of the sheet as measured after drying was adjusted to 25 μm. The sheet product was removed from the PET film and placed at the center of a setter made of zirconia and heated in an oxygen atmosphere (oxygen partial pressure: 0.1 MPa) at 850° C. for 5 hours, to thereby produce an (Ni_{0.75}Co_{0.2}Al_{0.05})O ceramic sheet of an “independent” sheet-like shape.

### (3) Crushing of Compact

The ceramic sheet produced through heating (calcination) was placed on a sieve (mesh) (opening: 15 μm), and then a spatula was lightly pressed against the ceramic sheet so as to cause the ceramic sheet to pass through the mesh for crushing, to thereby yield powdered (Ni_{0.75}Co_{0.2}Al_{0.05})O having a generally spherical particle shape. The thus-obtained (Ni_{0.75}Co_{0.2}Al_{0.05})O powder (100 parts) and ethanol (500 parts) were mixed by means of an ultrasonic dispersing apparatus (e.g., ultrasonic washing machine) while breaking of particles of the powder is prevented to the greatest possible extent, to thereby form a dispersion. Thereafter, the dispersion was caused to pass through a sieve (mesh) (opening: 5 μm), and the powder remaining on the sieve was dried at 150° C. for 5 hours, to thereby remove micropowder (particle size: ≦5 μm) formed during crushing.

(4) Mixing with Lithium Compound

The (Ni_{0.75}Co_{0.2}Al_{0.05})O powder from which micropowder had been removed was mixed with LiOH.H₂O powder (product of Wako Pure Chemical Industries, Ltd.) so as to attain a ratio by mole of Li/(Ni_{0.75}Co_{0.2}Al_{0.05}) of 1.05.

### (5) Firing Step (Lithium Incorporation Step)

The above powder mixture was put into a crucible made of high-purity alumina and heated in an oxygen atmosphere (0.1 MPa) at 750° C. for 12 hours, to thereby produce Li(Ni_{0.75}Co_{0.2}Al_{0.05})O₂ powder.

### (6) Evaluation of Cell Characteristics

In order to evaluate cell characteristics, a coin cell was fabricated in the following manner. Firstly, the above-produced Li(Ni_{0.75}Co_{0.2}Al_{0.05})O₂ powder, acetylene black, and poly(vinylidene fluoride) (PVDF) were mixed at proportion by mass of 75:20:5, to thereby prepare a cathode material. The thus-prepared cathode material (0.02 g) was press-molded at 300 kg/cm², to thereby form a disk (diameter: 20 mm) serving as a cathode active material layer. By use of the thus-produced cathode active material layer, a coin cell as shown in FIG. 1 was fabricated.

The electrolytic solution was prepared by dissolving LiPF₆ in an equivolume mixture of ethylene carbonate (EC) and diethyl carbonate (DEC) serving as an organic solvent to a concentration of 1 mol/L. By use of the thus-fabricated battery for characteristic evaluation (coin cell), percent rate capacity maintenance was evaluated.

### Examples 2 and 3

The procedure of Example 1 was repeated, except that the opening size of the sieve (mesh) was changed to 20 μm (Example 2) or 25 μm (Example 3) in “(3) Crushing of compact,” to thereby produce Li(Ni_{0.75}Co_{0.2}Al_{0.05})O₂ powder.

### Examples 4 and 5

The procedure of Example 1 was repeated, except that the feed rate (doctor blade method) was changed to 0.5 m/s (Example 4) or 5 m/s (Example 5) in “(2) Forming of raw material particles,” to thereby produce Li(Ni_{0.75}Co_{0.2}Al_{0.05})O₂ powder.

### Comparative Example 1

The procedure of Example 1 was repeated, except that NiO powder (product of Seido Kagaku Kogyo Co., Ltd.), Co₃O₄ powder (product of Seido Kagaku Kogyo Co., Ltd.), and Al₂O₃ powder (product of Showa Denko K.K.) were used as raw material particles, and that the opening size of the sieve (mesh) was changed to 25 μm in “(3) Crushing of compact,” to thereby produce Li(Ni_{0.75}Co_{0.2}Al_{0.05})O₂ powder.

Table 1 shows the results of Examples 1 to 5 and Comparative Example 1.

TABLE 1

| | | | | Characteristics of cathode active material powder | | | | Cell |
|---|---|---|---|---|---|---|---|---|
| | | | | | | | (003) Plane | characteristics |
| | Production conditions | | | Mean particle | Mean particle | Aspect | orientation | Rate capacity |
| | Raw | Feed rate | Mesh | size of primary | size of secondary | ratio of | degree (%) of | maintenance |
| | material | (m/s) in | opening | particles | particles | secondary | primary particles in | (2 C/0.1 C) |
| | compound | formation | (μm) | (μm) | (μm) | particles | secondary particle | (%) |
| Ex. 1 | Hydroxide | 1 | 15 | 0.7 | 13 | 1.1 | 70 | 94 |
| Ex. 2 | | 1 | 20 | 0.8 | 16 | 1.3 | 70 | 92 |
| Ex. 3 | | 1 | 25 | 0.7 | 20 | 1.5 | 70 | 91 |
| Comp. | Oxide | 1 | 25 | 0.7 | 14 | 1.1 | 25 | 85 |
| Ex. 1 | | | | | | | | |
| Ex. 4 | Hydroxide | 0.5 | 15 | 0.8 | 13 | 1.1 | 50 | 90 |
| Ex. 5 | | 5 | 15 | 0.7 | 13 | 1.1 | 90 | 95 |

As is clear from Table 1, an excellent rate characteristic was realized in Examples 1 to 5, in which the (003) plane orientation degree was 50% or more. Particularly, the higher the (003) plane orientation degree, the more improved the rate characteristic (see Examples 1, 4, and 5). As the aspect ratio of the secondary particles reached 1.0, the rate characteristic was improved (see Examples 1 to 3). In contrast, the rate characteristic was poor in Comparative Example 1, in which the (003) plane orientation degree was less than 50%.

### 5-2: Ternary Composition

### Example 6

The procedure of Example 1 was repeated, except that a mixture of Ni(OH)₂ powder (product of Kojundo Chemical Lab. Co., Ltd.), Co(OH)₂ powder (product of Kojundo Chemical Lab. Co., Ltd.), and MnCO₃ powder (product of Tosoh Corporation) having proportions by mole among Ni, Co, and Al of 0.33:0.33:0.33 was prepared in “(1) Preparation of raw material particles” and that heating was performed at 950° C. for 12 hours in air (0.02 MPa) in “(5) Firing,” to thereby produce Li(Ni_{0.33}Co_{0.33}Mn_{0.33})O₂ powder.

### Examples 7 and 8

The procedure of Example 6 was repeated, except that the opening size of the sieve (mesh) was changed to 20 μm (Example 7) or 25 μm (Example 8) in “(3) Crushing of compact,” to thereby produce Li(Ni_{0.33}Co_{0.33}Mn_{0.33})O₂ powder.

### Examples 9 and 10

The procedure of Example 6 was repeated, except that the feed rate (doctor blade method) was changed to 0.7 m/s (Example 9) or 6 m/s (Example 10) in “(2) Forming of raw material particles,” to thereby produce Li(Ni_{0.33}Co_{0.33}Mn_{0.33})O₂ powder.

### Comparative Example 2

The procedure of Example 6 was repeated, except that NiO powder (product of Seido Kagaku Kogyo Co., Ltd.), MnCO₃ powder (product of Tosoh Corporation), and Co₃O₄ powder (product of Seido Kagaku Kogyo Co., Ltd.) were used as raw material particles, and that the opening size of the sieve (mesh) was changed to 25 μm in “(3) Crushing of compact,” to thereby produce Li(Ni_{0.33}Co_{0.33}Mn_{0.33})O₂ powder.

Table 2 shows the results of Examples 6 to 10 and Comparative Example 2.

TABLE 2

| | | | | Characteristics of cathode active material powder | | | | Cell |
|---|---|---|---|---|---|---|---|---|
| | | | | | | | (003) Plane | characteristics |
| | Production conditions | | | Mean particle | Mean particle | Aspect | orientation | Rate capacity |
| | Raw | Feed rate | Mesh | size of primary | size of secondary | ratio of | degree (%) of | maintenance |
| | material | (m/s) in | opening | particles | particles | secondary | primary particles in | (2 C/0.1 C) |
| | compound | formation | (μm) | (μm) | (μm) | particles | secondary particle | (%) |
| Ex. 6 | Hydroxide | 1 | 15 | 1.1 | 14 | 1.1 | 70 | 93 |
| Ex. 7 | | 1 | 20 | 1.0 | 18 | 1.3 | 70 | 92 |
| Ex. 8 | | 1 | 25 | 1.2 | 21 | 1.5 | 70 | 90 |
| Comp. | Oxide | 1 | 25 | 1.2 | 14 | 1.1 | 25 | 83 |
| Ex. 2 | | | | | | | | |
| Ex. 9 | Hydroxide | 0.7 | 15 | 0.9 | 13 | 1.1 | 50 | 88 |
| Ex. 10 | | 6 | 15 | 1.1 | 14 | 1.1 | 90 | 94 |

As is clear from Table 2, an excellent rate characteristic was realized in Examples 6 to 10, in which the (003) plane orientation degree was 50% or more. Particularly, the higher the (003) plane orientation degree, the more improved the rate characteristic (see Examples 6, 9, and 10). As the aspect ratio of the secondary particles reached 1.0, the rate characteristic was improved (see Examples 6 to 8). In contrast, the rate characteristic was poor in Comparative Example 2, in which the (003) plane orientation degree was less than 50%. The results were the same as obtained in the cases of different compositions shown in Table 1.

### 5-3: Solid Solution-Based Material

### Example 11

### (1) Preparation of Raw Material Particles and Slurry Containing the Same

An aqueous solution of sulfate salts of Ni, Co, and Mn having proportions by mole among Ni, Co, and Mn of 16.3:16.3:67.5 was prepared. The thus-prepared aqueous sulfate salt solution was caused to react with NaOH in a hot bath at 50° C., to thereby yield a co-precipitated hydroxide. The co-precipitated hydroxide was mixed and pulverized by means of a ball mill for 16 hours, to thereby prepare a powder of raw material particles. A slurry was prepared from the raw material particle powder (100 parts) under the same conditions as employed in Example 1.

### (2) Forming of Raw Material Particles and Heating

The thus-prepared slurry was formed into a sheet on a PET film through the doctor blade process (feed rate: 1 m/s) such that the thickness of the sheet as measured after drying was adjusted to 40 μm. The sheet product was removed from the PET film and placed at the center of a setter made of zirconia and heated in air at 300° C. for 1 hour, to thereby produce an (Ni_{0.16}Co_{0.16}Mn_{0.68})O ceramic sheet of an “independent” sheet-like shape.

### (3) Crushing of Compact

The ceramic sheet produced through heating (calcination) was placed on a sieve (mesh) (opening: 15 μm), and then a spatula was lightly pressed against the ceramic sheet so as to cause the ceramic sheet to pass through the mesh for crushing, to thereby yield powdered (Ni_{0.16}Co_{0.16}Mn_{0.68})O having a generally spherical particle shape. The thus-obtained (Ni_{0.16}Co_{0.16}Mn_{0.68})O powder (100 parts) and ethanol (500 parts) were mixed by means of an ultrasonic dispersing apparatus (e.g., ultrasonic washing machine) or the like while breaking of particles of the powder is prevented to the greatest possible extent, to thereby form a dispersion. Thereafter, the dispersion was caused to pass through a sieve (mesh) (opening: 5 μm), and the powder remaining on the sieve was dried at 100° C. for 5 hours, to thereby remove micropowder (particle size: formed during crushing.

(4) Mixing with Lithium Compound

The (Ni_{0.16}Co_{0.16}Mn_{0.68})O powder from which micropowder had been removed was mixed with LiOH.H₂O powder (product of Wako Pure Chemical Industries, Ltd.) so as to attain a ratio by mole of Li/(Ni_{0.16}Co_{0.16}Mn_{0.68}) of 1.40.

### (5) Firing Step

The above powder mixture was put into a crucible made of high-purity alumina and heated in air at 900° C. for 12 hours, to thereby produce Li_{1.2}(Ni_{0.13}Co_{0.13}Mn_{0.54})O₂ powder.

### (6) Evaluation of Cell Characteristics

The procedure of Example 1 was repeated, except that the cathode material was prepared from the thus-produced Li_{1.2}(Ni_{0.13}Co_{0.13}Mn_{0.54})O₂ powder, to thereby fabricate a coin-cell type battery. The percent rate capacity maintenance of the battery employing the solid solution-based material was evaluated in the following manner.

The coin cell was subjected to constant-current charging at 0.1 C rate of current until the cell voltage became 4.8 V; subsequently, constant-voltage charging was carried out under a current condition of maintaining the cell voltage at 4.8 V, until the current dropped to 1/20, followed by 10 minutes rest; and then, constant-current discharging was carried out at 0.1 C rate of current until the cell voltage became 2.0 V, followed by 10 minutes rest. These charge-discharge operations consisted one cycle, and two cycles in total were repeated under a condition of 25° C. The discharge capacity in the second cycle was measured, to thereby obtain the “discharge capacity at a 0.1 C rate.”

Subsequently, the above two cycles of charge-discharge operations were repeated, except that the current upon charging was maintained at a 0.1 C rate and that upon discharging changed to a 2 C rate. The discharge capacity in the second cycle was measured, to thereby obtain the “discharge capacity at a 2 C rate.”

“Discharge capacity at a 2 C rate” was divided by “discharge capacity at a 0.1 C rate,” and the ratio was employed as percent rate capacity maintenance (as percentage).

### Comparative Example 3

The procedure of Example 11 was repeated, except that a raw material powder (100 parts) prepared by pulverizing a mixture of NiO powder (product of Seido Kagaku Kogyo Co., Ltd.), Co₃O₄ powder (product of Seido Kagaku Kogyo Co., Ltd.), and MnCO₃ powder (product of Tosoh Corporation) for 16 hours by means of a ball mill was employed instead of the co-precipitated hydroxide of Example 11, to thereby produce Li_{1.2}(Ni_{0.13}Co_{0.13}Mn_{0.54})O₂ powder.

### Example 11′

The procedure of Example 11 was repeated, except that (1) bismuth oxide (product of Taiyo Koko Co., Ltd.) is added to the raw material particle powder of Example 11 so as to attain mass fraction of bismuth oxide in a total mass of mixture after addition of bismuth oxide of 1.0 wt % and (2) the mixing step with lithium compound was performed so as to attain a ratio by mole of Li/(Ni_{0.75}Co_{0.2}Al_{0.05}) of 1.30, then solid solution-based material powder was chemically-synthesized.

Table 3 shows the results of Example 11, Example 11′ and Comparative Example 3.

TABLE 3

| | | | | Characteristics of cathode active material powder | | | | Cell |
|---|---|---|---|---|---|---|---|---|
| | | | | | | | (003) Plane | characteristics |
| | Production conditions | | | Mean particle | Mean particle | Aspect | orientation | Rate capacity |
| | Raw | Feed rate | Mesh | size of primary | size of secondary | ratio of | degree (%) of | maintenance |
| | material | (m/s) in | opening | particles | particles | secondary | primary particles in | (2 C/0.1 C) |
| | compound | formation | (μm) | (μm) | (μm) | particles | secondary particle | (%) |
| Ex. 11 | Hydroxide | 1 | 15 | 0.8 | 15 | 1.1 | 80 | 85 |
| Ex. 11′ | Hydroxide | 1 | 15 | 0.5 | 12 | 1.1 | 82 | 85 |
| Comp. | Oxide | 1 | 15 | 0.8 | 14 | 1.1 | 20 | 65 |
| Ex. 3 | | | | | | | | |

As is clear from Table 3, also in the case of a solid solution-based material having a composition of Li_{1.2}(Ni_{0.13}Co_{0.13}Mn_{0.54})O₂, an excellent rate characteristic was realized in Example 11 in which the (003) plane orientation degree was 50% or more, and the rate characteristic was poor in Comparative Example 3, in which the (003) plane orientation degree was less than 50%.

### 5-4. Calcination and Sphering Treatment

### Examples 12 to 19

### (1) Preparation of Raw Material Particles and Slurry Containing the Same

A mixture Ni(OH)₂ powder (product of Kojundo Chemical Lab. Co., Ltd.), Co(OH)₂ powder (product of Kojundo Chemical Lab. Co., Ltd.), and Al₂O₃.H₂O (product of SASOL) having proportions by mole among Ni, Co, and Al of 80:15:5 was prepared. The mixture was mixed and pulverized by means of a ball mill for 24 hours, to thereby prepare a powder of raw material particles.

The thus-prepared raw material particle powder (100 parts) was mixed with a dispersion medium (pure water) (400 parts), a binder (polyvinyl alcohol: product No. VP-18; product of Japan VAM & Poval Co., Ltd.) (1 part), a dispersant (Malialim KM-0521; product of NOF Corporation) (1 part), and a defoaming agent (1-octanol: product of Wako Pure Chemical Industries, Ltd.) (0.5 parts). The resultant mixture was stirred under reduced pressure for defoaming, and the viscosity thereof was adjusted to 0.5 Pa·s, to thereby form a slurry. The viscosity was measured by means of an LVT-type viscometer (product of Brookfield Co., Ltd.).

### (2) Forming of Raw Material Particles and Heating (Calcination)

The thus-prepared slurry was formed into a sheet on a PET film through the doctor blade process such that the thickness of the sheet as measured after drying was adjusted to 25 μm. The sheet product was removed from the PET film was placed at the center of a setter made of zirconia and heated in air at 900° C. for 3 hours, to thereby produce an (Ni_{0.8}Co_{0.15}Al_{0.05})O ceramic sheet of an “independent” sheet-like shape.

### (3) Crushing of Compact

The ceramic sheet produced through heating (calcination) was placed on a sieve (mesh) (opening: 20 μm), and then a spatula was lightly pressed against the ceramic sheet so as to cause the ceramic sheet to pass through the mesh for crushing, to thereby yield powdered (Ni_{0.8}Co_{0.15}Al_{0.05})O having a generally spherical particle shape.

### (4) Sphering Treatment and Classification of Crushed Product

The (Ni_{0.8}Co_{0.15}Al_{0.05})O powder produced through crushing was supplied to an air classifier (Turbo Classifier, model: TC-15, product of Nisshin Engineering Ltd., exhaust air flow rate: 1.7 m³/min, classification rotor rotation: 10,000 rpm) at a rate of 20 g/min. A powder having larger particle size was recovered from the starting powder. The sphering treatment (concomitant with classification through removal of micropowder) was repeated five times.

(5) Mixing with Lithium Compound

The (Ni_{0.8}Co_{0.15}Al_{0.05})O powder from which micropowder had been removed was mixed with LiOH.H₂O powder (product of Wako Pure Chemical Industries, Ltd.) so as to attain a ratio by mole of Li/(Ni_{0.8}Co_{0.15}Al_{0.05}) of 1.05.

### (6) Firing Step (Lithium Incorporation Step)

The above powder mixture was put into a crucible made of high-purity alumina and heated in an oxygen atmosphere (0.1 MPa) at 750° C. for 24 hours, to thereby produce Li(Ni_{0.8}Co_{0.15}Al_{0.05})O₂ powder (Example 19).

The aforementioned production method of Example 19 was repeated. However, the feed rate employed in tape formation or the mesh opening size was changed, and calcination or sphering was performed or was not performed. In the case where sphering was omitted, the same classification treatment as performed in Example 1 was conducted. Thus, powder samples of Examples 12 to 18 and Example 20, and of Comparative Example 6 were produced (see Table 4).

Instead of tape formation, spray drying was performed, to thereby form powder samples of Comparative Examples 4 and 5 (see Table 4). Formation of powder through spray drying was carried out by means of a spray dryer (Turning Spray Dryer TSR-3W, product of Sakamoto Engineering) at a liquid feed rate of 40 g/min, an inlet temperature of 200° C., and an atomizer rotation of 13,000 rpm, whereby spherical granules were formed.

### (7) Evaluation

The thus-produced powder samples of Examples 12 to 20 and Comparative Examples 4 to 6 were evaluated in a manner similar to that employed in Example 1 or the like. In Examples 12 to 20 and Comparative Examples 4 to 6, the aspect ratio of particles before firing (precursor particles) was determined through the aforementioned method. Examples 12 to 20 and Comparative Examples 4 to 6 employed an evaluation battery for evaluating cell characteristics which was fabricated through the same method as employed in Example 1, except the following procedure.

Specifically, the above-produced Li(Ni_{0.8}Co_{0.15}Al_{0.05})O₂ powder, acetylene black, and poly(vinylidene fluoride) (PVDF) were mixed at proportion by mass of 90:5:5, and the mixture was dispersed in N-methyl-2-pyrrolidone, to thereby prepare a cathode active material paste. The thus-prepared cathode active material paste was applied onto a cathode collector (aluminum foil, thickness: 20 μm) such that a uniform coating thickness (50 μm after drying) was attained. A disk (diameter: 14 mm) was punched out from the dried sheet and pressed at 2,000 kg/cm², to thereby form a cathode plate. By use of the thus-produced cathode plate, a coin cell as shown in FIG. 1 was fabricated.

Table 4 shows the results of Examples 12 to 20 and Comparative Examples 4 to 6.

TABLE 4

| | | | | | | | Characteristics of cathode active material powder | | | Cell |
|---|---|---|---|---|---|---|---|---|---|---|
| | Production conditions | | | | | | | | (003) Plane | characteristics |
| | | | | | | Aspect | Mean particle | Aspect | orientation | Rate capacity |
| | | Feed rate | | Mesh | | ratio of | size of secondary | ratio of | degree (%) of | maintenance |
| | Formation | (m/s) in | | opening | | precursor | particles | secondary | primary particles in | (2 C/0.1 C) |
| | method | formation | Calcining | (μm) | Sphering | particles | (μm) | particles | secondary particle | (%) |
| Comp. | Spray | — | no | — | — | 1.1 | 17 | 1.1 | 0 | 85 |
| Ex. 4 | drier | | | | | | | | | |
| Comp. | Spray | — | yes | — | — | 1.1 | 17 | 1.1 | 0 | 85 |
| Ex. 5 | drier | | | | | | | | | |
| Ex. 12 | Tape | 1 | no | 15 | no | 1.1 | 13 | 1.1 | 70 | 94 |
| | formation | | | | | | | | | |
| Ex. 13 | Tape | 1 | no | 15 | Air | 1.1 | 13 | 1.1 | 70 | 96 |
| | formation | | | | classification | | | | | |
| Ex. 14 | Tape | 1 | no | 20 | no | 1.3 | 16 | 1.3 | 70 | 92 |
| | formation | | | | | | | | | |
| Ex. 15 | Tape | 1 | no | 20 | Air | 1.3 | 16 | 1.3 | 70 | 94 |
| | formation | | | | classification | | | | | |
| Ex. 16 | Tape | 1 | no | 25 | no | 1.5 | 20 | 1.5 | 70 | 91 |
| | formation | | | | | | | | | |
| Ex. 17 | Tape | 1 | no | 25 | Air | 1.5 | 20 | 1.5 | 70 | 92 |
| | formation | | | | classification | | | | | |
| Ex. 18 | Tape | 1 | yes | 20 | no | 1.2 | 16 | 1.2 | 70 | 93 |
| | formation | | | | | | | | | |
| Ex. 19 | Tape | 1 | yes | 20 | Air | 1.1 | 15 | 1.1 | 70 | 95 |
| | formation | | | | classification | | | | | |
| Ex. 20 | Tape | 0.5 | yes | 20 | no | 1.2 | 13 | 1.2 | 50 | 90 |
| | formation | | | | | | | | | |
| Comp. | Tape | 0.1 | no | 20 | Air | 1.1 | 13 | 1.1 | 20 | 86 |
| Ex. 6 | formation | | | | classification | | | | | |

As is clear from Table 4, the powder samples of Comparative Examples 4 and 5 (granulated through spray drying) and the powder sample of Comparative Example 6 (low shear rate in tape formation) exhibited low orientation degrees and poor rate characteristic. In contrast, in Examples 12 to 20, high orientation degrees and excellent rate characteristic were attained.

Comparison was made among the samples of Examples 12 to 20. The sample of Example 13 which had undergone sphering exhibited more excellent rate characteristic than that of the sample of Example 12 which had undergone no sphering. Similarly, the sample of Example 15 which had undergone sphering exhibited more excellent rate characteristic than that of the sample of Example 14 which had undergone no sphering. The relation between Examples 16 and 17, and that between Examples 18 and 19 were the same. The samples of Examples 13, 14, 17, 18 (employment of the same mesh) were further investigated. Among them, the particles of Examples 18 and 19 (calcination performed) have an aspect ratio of approximately 1 and provided more excellent rate characteristic.

FIG. 8 is an SEM photoimage of the cathode active material particles of Example 19. FIG. 9 an SEM photoimage of the same particles of the Example (specifically, Example 19) at a higher magnification.

FIG. 9 is a graph showing discharge characteristics of batteries employing cathode active material particles of an Example and a Comparative Example. In FIG. 9, a solid line represents a discharge characteristic of the particles of Example 19, and a dashed line represents a discharge characteristic of the particles of Comparative Example 4. As shown in FIG. 9, by use of the particles of the Example, high voltage can be maintained just before the end of discharge, since the internal resistance of the cathode is thought to be reduced by the particles of the Example.

Under discharge at a 1 C current density, the ratio of discharge capacity at a discharge voltage of 3.5 V to discharge capacity at a discharge voltage of 3 V (cut-off voltage) was obtained as an index P for evaluating the degree of polarization. When P is approximately 1, polarization is small, which is preferred.

The polarization was evaluated in the case where the particles of Example 19 (oriented) were used and in the case where the particles of Comparative Example 9 (non-oriented) were used, the two particle samples having almost the same particle size and particle shape. As shown in FIG. 10, the index P on the discharge curve of Comparative Example 4 indicates 0.92, while the index P on the discharge curve of Example 19 indicates 0.97. Thus, polarization at the end of discharge was found to be considerably improved by virtue of controlling orientation of cathode active material particles.

The cycle characteristic was evaluated in the case where the particles of Example 13 (oriented) were used and in the case where the particles of Comparative Example 2 (non-oriented) were used, the two particle samples having almost the same particle size and particle shape. A cell was fabricated, and the cell was tested at 25° C. by subjecting the cell to a cyclic charge-discharge process including (1) charging at 1 C rate constant current-constant voltage to 4.3 V and (2) discharge at 1 C rate constant current to 3.0 V. Before and after repetition of the cyclic process 50 times, the percent rate capacity maintenance of the cell (2 C/0.1 C, the same as in Example 1) was measured, and the change in the ratio was employed as an index of cycle characteristic. In Comparative Example 2, the ratio decreased from 85% to 74% after cyclic charge-discharge events, while in Example 13, the drop was merely from 95% to 90%. Thus, deterioration in charge-discharge characteristics (particularly, rate characteristic), which would otherwise be caused by repeated charge-discharge cycles, was prevented by virtue of controlling orientation of cathode active material particles.

Table 5 shows the effects of the formation method and sphering on characteristics of cathode active materials having a composition (Li(Ni_{0.5}Co_{0.2}Mn_{0.3})O₂), which differs from that employed in Table 4. In the case of Table 5, since the composition contained manganese, adverse effects such as phase separation were thought to occur in calcination. Thus, no calcination was performed.

TABLE 5

| | | | | | | | Characteristics of cathode active material powder | | | Cell |
|---|---|---|---|---|---|---|---|---|---|---|
| | Production conditions | | | | | | | | (003) Plane | characteristics |
| | | | | | | Aspect | Mean particle | Aspect | orientation | Rate capacity |
| | | Feed rate | | Mesh | | ratio of | size of secondary | ratio of | degree (%) of | maintenance |
| | Formation | (m/s) in | | opening | | precursor | particles | secondary | primary particles in | (2 C/0.1 C) |
| | method | formation | Calcining | (μm) | Sphering | particles | (μm) | particles | secondary particle | (%) |
| Comp. | Spray | | no | 15 | — | 1 | 17 | 1 | 0 | 80 |
| Ex. 7 | drier | | | | | | | | | |
| Ex. 21 | Tape | 1 | no | 15 | no | 1.1 | 14 | 1.1 | 70 | 93 |
| | formation | | | | | | | | | |
| Ex. 22 | Tape | 1 | no | 20 | Air | 1.1 | 14 | 1.1 | 70 | 96 |
| | formation | | | | classification | | | | | |
| Ex. 23 | Tape | 1 | no | 20 | no | 1.3 | 18 | 1.3 | 70 | 92 |
| | formation | | | | | | | | | |
| Ex. 24 | Tape | 1 | no | 25 | Air | 1.3 | 18 | 1.3 | 70 | 93 |
| | formation | | | | classification | | | | | |
| Ex. 25 | Tape | 1 | no | 25 | no | 1.5 | 22 | 1.5 | 70 | 90 |
| | formation | | | | | | | | | |
| Ex. 26 | Tape | 1 | no | 25 | Air | 1.5 | 22 | 1.5 | 70 | 92 |
| | formation | | | | classification | | | | | |
| Ex. 27 | Tape | 0.5 | no | 20 | no | 1.1 | 16 | 1.1 | 50 | 89 |
| | formation | | | | | | | | | |
| Comp. | Tape | 0.1 | no | 20 | Air | 1.1 | 17 | 1.1 | 25 | 82 |
| Ex. 8 | formation | | | | classification | | | | | |

As is clear from Table 5, the same results as shown in Table 4 were obtained cathode active substances having different compositional proportions were used.

In the meantime, the aspect ratios of the primary particles with respect to Examples 1, 6, 11, 13 and 22 were determined. The results were 1.2, 1.3, 1.2, 1.3, and 1.2, respectively.

### 6. EXAMPLES OF MODIFICATIONS

The above-described embodiment and specific examples are, as mentioned above, mere examples of the best mode of the present invention which the applicant of the present invention contemplated at the time of filing the present application. The above-described embodiment and specific examples should not be construed as limiting the invention. Various modifications to the above-described embodiment and specific examples are possible, so long as the invention is not modified in essence.

Several modifications will next be exemplified. In the following description of the modifications, component members similar in structure and function to those of the above-described embodiment are denoted by names and reference numerals similar to those of the above-described embodiment. The description of the component members appearing in the above description of the embodiment can be applied as appropriate, so long as no inconsistencies are involved.

Needless to say, even modifications are not limited to those described below. Limitingly construing the present invention based on the above-described embodiment and the following modifications impairs the interests of an applicant (particularly, an applicant who is motivated to file as quickly as possible under the first-to-file system) while unfairly benefiting imitators, and is thus impermissible.

The structure of the above-described embodiment and the structures of the modifications to be described below are entirely or partially applicable in appropriate combination, so long as no technical inconsistencies are involved.

No particular limitation is imposed on the configuration of the lithium secondary battery 1 to which the present invention is applied. For example, the present invention is not limited to the aforementioned specific cell configurations. The present invention is also suitably applicable to a cylindrical lithium secondary battery 1 shown in FIG. 11, in which elements are wound about a core 7. The present invention is not limited to the configuration of the liquid-type cell. Thus, gel polymer electrolyte or polymer electrolyte may be used as the electrolyte of the present invention.

As shown in FIG. 12, a surface portion of the cathode active material particle 222 may have an orientation degree lower than that in the inner portion of the particle. According to this configuration, even in portions (areas enclosed by broken lines in FIG. 12) of the particle having numerous (003) planes—with difficulty in intercalation/deintercalation of lithium ions and electrons—exposed widely to the outside, intercalation/deintercalation of lithium ions is promoted between the single-crystal primary particles 222a and the electrolyte surrounding the particle 222, whereby rate characteristic is improved. Such a surface portion may be provided by causing micropowder formed during crushing or sphering to adhere on the particle. This can be attained by appropriately controlling the crushing or sphering conditions. Notably, the inter-particle microstructure may be evaluated through, for example, EBSD (electron backscatter diffractometry) in the SEM observation of a cross-section of a secondary particle (finished by means of a cross-section polisher (CP), focused ion beam (FIB), etc.), or crystal orientation analysis in the TEM observation thereof.

The present invention is not limited to the aforementioned specific production methods. For example, the forming method is not limited to the aforementioned forming methods. Alternatively, when the raw materials are appropriately selected before forming, the aforementioned firing step (incorporation of lithium) may be omitted.

Even when raw material particles of oxide are used (see, for example, Comparative Example 1), there may be formed cathode active material precursor particles 703 or cathode active material precursor particles 704 in which raw material particles 701 are present in the compact with arranged crystal orientations, through application of a magnetic field during formation of the compact. Therefore, the present invention is not limited to the case where raw material particles of hydroxide are employed.

The cathode active material precursor particles of the present invention may be supplied to the market in the form containing a lithium compound (including presence of a lithium compound in the particles and/or addition of a lithium compound to the particles) or in the form of a mixture with a lithium compound. In this case, the particles containing a lithium compound or a mixture of the particles with a lithium compound may be referred to as “cathode active material precursor particles forming cathode active material particles of a lithium secondary battery through thermal treatment.” Needless, to say, the present invention also encompasses these precursor particles.

Needless to say, those modifications which are not particularly referred to are also encompassed in the technical scope of the present invention, so long as the invention is not modified in essence.

Those components which partially constitute means for solving the problems to be solved by the present invention and are illustrated with respect to operations and functions encompass not only the specific structures disclosed above in the description of the above embodiment and modifications but also any other structures that can implement the operations and functions. Further, the contents (including specifications and drawings) of the prior application and publications cited herein can be incorporated herein as appropriate by reference.

1. A lithium secondary battery cathode active material having a layered rock salt structure, characterized in that
the material is formed of a large number of primary particles having a mean particle size of 0.01 to 5 μm;
the material contains secondary particles which have a mean particle size of 1 to 100 μm and an aspect ratio, which is expressed as a value calculated by dividing a long axis diameter by a short axis diameter, of 1.0 or more and less than 2; and
the primary particles forming the secondary particle have a (003) plane orientation degree of 50% or higher.

2. A lithium secondary battery cathode active material according to claim 1, wherein the plane orientation degree is 70% or more.

3. A lithium secondary battery cathode active material according to claim 1, wherein the secondary particles have an aspect ratio of 1.1 to 1.5.

4. A lithium secondary battery having a cathode including a cathode active material layer and an anode including an anode active material layer, characterized in that
the cathode active material layer contains a cathode active material in the form of secondary particles each being formed of a mass of a plurality of singe-crystal primary particles of a lithium complex oxide having a layered rock salt structure;
the primary particles have a mean particle size of 0.01 to 5 μm; and
the secondary particles have an aspect ratio, which is expressed as a value calculated by dividing a long axis diameter by a short axis diameter, of 1.0 or more and less than 2, a mean particle size of 1 to 100 μm, and a (003) plane orientation degree of 50% or higher.

5. A lithium secondary battery according to claim 4, wherein the plane orientation degree is 70% or more.

6. A lithium secondary battery according to claim 4, wherein the secondary particles have an aspect ratio of 1.1 to 1.5.

7. A lithium secondary battery cathode active material according to claim 2, wherein the secondary particles have an aspect ratio of 1.1 to 1.5.

8. A lithium secondary battery according to claim 5, wherein the secondary particles have an aspect ratio of 1.1 to 1.5.
